(19) United States
(12) Patent Application Publication
(10) Pub. No.: US 2026/0341792 A1
(43) Pub. Date: Oct. 29, 2026

(54) ELECTROLYTES

(71) Applicant: FARADION LIMITED, Sheffield South Yorkshire (GB)

(72) Inventors: Christopher John WRIGHT, Sheffield South Yorkshire (GB); Ashish RUDOLA, Sheffield South Yorkshire (GB); Jeremy BARKER, Sheffield South Yorkshire (GB)

(21) Appl. No.: 19/103,692

(22) PCT Filed: May 5, 2023
(86) PCT No.: PCT/GB2023/051201

§ 371 Date: Feb. 13, 2025

(30) Foreign Application Priority Data
Aug. 23, 2022 (GB) 2212271.7

(51) Int. Cl. H01M 10/0569; H01M 10/054; H01M 10/0567

(52) U.S. Cl. CPC H01M 10/0569; H01M 10/054; H01M 10/0567; H01M 2300/0028

(57) ABSTRACT

The invention relates to the use, as electrolyte, of a composition comprising a solvent system which comprises a first component comprising one or more non-aqueous solvents and a second component comprising one or more performance additives. Devices and methods including electrolytes compositions are also disclosed.

### FIELD OF THE INVENTION

The present invention relates to compositions and their use, as an electrolyte (i.e., an “electrolyte composition”), preferably, in an electrochemical cell. Methods, devices and apparatuses using said electrolyte compositions are also disclosed.

### BACKGROUND OF THE INVENTION

Metal-ion cells (e.g. alkali metal-ion cells such as sodium-ion cells; potassium-ion cells; lithium-ion cells) are reusable secondary batteries that comprise an anode (negative electrode), a cathode (positive electrode) and an electrolyte material, and are capable of storing energy.

Metal-ion cells comprise an active material layer coated on a current collector foil to form a cathode, and a similar arrangement exists for a corresponding anode. The cathode and anode are physically separated by a separator which allows for a flow of ions within a liquid electrolyte medium, which is present uniformly within the cell and wets the entire cathode, anode and separator. When a metal-ion cell is charging, Na⁺ (or K⁺, Li⁺) ions shuttle from the cathode active material and are inserted in the anode active material (electrons flow through the external circuit) and the reverse process occurs during discharging (sodium ions are extracted from the anode active material and are inserted into the cathode active material with the electrons flowing through the external circuit, doing the useful work).

An “anode-free cell sodium cell” refers to a cell in which the working principle of the anode-free sodium cell involves sodium metal cation (Na⁺) extraction/insertion from the cathode active material, and sodium metal (Na) plating/stripping at an anode current collector. This working principle is different from a metal-ion cell discussed above in which the working principle of the metal-ion cell involves metal cation (e.g. Na⁺, K⁺, Li⁺) extraction/insertion at the cathode active material, and metal cation (e.g. Na⁺, K⁺, Li⁺) extraction/insertion at the anode active material.

One area that needs more attention is the development of suitable electrolyte compositions, particularly for use in metal-ion cells and/or anode-free sodium cells.

The primary purpose of an electrolyte composition in both a metal-ion cell and an anode-free sodium cell is to provide a channel of transport for the positive electroactive metal-ions, meanwhile prohibiting transfer of the electrons through the same medium. The importance of the electrolyte composition should not therefore be overlooked because, it is, in a large part, key to cell life, and for determining the practical performance achievable by a cell, for instance in terms of capacity, rate capability, and safety etc.

Until now, conventional theory has dictated that in order for an electrolyte composition in a metal-ion cell to be functional, it must contain a metal-ion salt. In support of this, the Applicant refers to section 14B.3 “Lithium Salts” of Chapter 14, page 322 of Huggins (“Advanced Batteries: Materials Science Aspect”, Springer, 2008) where it is stated that “To operate as an electrolyte in lithium cells, [these] solvents have to contain lithium salts”.

It has also widely been accepted in the battery community that the ionic conductivity (mS/cm) of a liquid electrolyte is important in determining the kinetic response of a battery. In support of this, the Applicant refers to Chayambuka et al. (“An experimental and modelling study of sodium-ion battery electrolytes”, Journal of Power Sources, 516, 2021, 230658) This document demonstrates by use of a model experiment that when there is zero concentration of NaPF₆ salt in a 1:1 mixed ethylene carbonate:propylene carbonate electrolyte, the conductivity (mS/cm) of the electrolyte is also predicted to be zero.

In fact, FIG. 3a of Chayambuka et al. shows that in dilute electrolyte solutions, ionic conductivity actually increases with the sodium salt concentration until an optimum concentration of approximately 1 mol kg⁻¹ is reached.

Similarly, FIGS. 4 and 6 of Logan et al., (“A Critical Evaluation of the Advanced Electrolyte Model”, J. Electrochem. Soc., 165, 2018) reiterate the teachings of Chayambuka, namely that a zero concentration of both lithium and sodium salts would yield zero electrolyte ionic conductivity.

As such, there is a general teaching at this present time that an electrolyte composition that is substantially free of one or more metal-containing salts would incur infinite polarisation of the liquid electrolyte, irrespective of the battery C-rate. Thus, the electrolyte composition would, on the face of it, result in zero ionic conductivity, and accordingly forbid charge/discharge of the cell; i.e. the cell/battery would not be expected to operate at all.

Battery usage, and thus, electrolyte usage is becoming more widespread, particularly in stationary and automotive applications (e.g., electric vehicles). However, because of certain suspected environmental problems, including the generation of toxic and corrosive gases associated with the use of non-renewable fossil fuels it has become increasingly desirable to use batteries (perhaps in combination with renewable fuels), and thus, electrolyte compositions in such batteries, having low or even zero levels of toxicity and/or corrosiveness.

Thus, there is a need for a low or non-toxic and/or low or non-corrosive electrolyte composition that offers batteries which are alternative to and are considered environmentally safer substitutes for fossil fuels.

Furthermore, electric vehicle manufacturers (for instance) are under growing pressure to make their vehicles lighter to improve efficiency and performance. It is also desirable to make batteries that are lighter and easier to install in stationary application. Thus, there is a need for batteries, and thus electrolyte compositions, that offer alternative to, and are considered lighter (i.e., are of lower density) substitutes for, existing electrolyte compositions.

It is generally considered however, that to be a suitable electrolyte composition it must fulfil a long list of attributes, which include:
Chemical stability—there must be no reactions during the cell operation, including within the electrolyte itself or with the separator, the electrodes, current collectors or the packaging materials used;
Electrochemical stability—there must be a wide electrochemical stability window i.e., a large separation between the high and low onset potentials for decomposition by oxidation or reduction;
Thermal stability—the electrolyte composition must not decompose or chemically break down during normal cell operation and operational temperature;
Physical properties—the electrolyte composition needs to be liquid therefore its melting and boiling points must be well outside the internal operating temperatures of the cell;
High ionic and low electronic conductivities are necessary to maintain cell operation by metal-ion transport and to minimize self-discharge of the cell, respectively;
Based on sustainable chemistries, i.e., made using abundant elements and via low impact syntheses (energy, pollution etc.); and
Cost effective production.

With regard to efficiency in use, it is important to note that a loss in cycling or rate performance of the electrolyte composition may have secondary environmental impacts through increased fossil fuel usage arising from an increased demand for electrical energy.

Furthermore, it is generally considered desirable for a low or non-toxic and/or low or non-corrosive and/or low-density electrolyte composition to be effective in a battery without major changes to conventional battery manufacturing technology.

The invention therefore aims to mitigate or eliminate one or more of the aforesaid disadvantages of the known art.

### SUMMARY OF THE INVENTION

The present invention achieves these aims by providing: the use, as an electrolyte, of a composition comprising a solvent system which comprises:
a first component comprising one or more non-aqueous solvents;
a second component comprising one or more performance additives; and
wherein the electrolyte composition comprises a concentration from 0 mol/kg to ≤0.2 mol/kg of metal-containing salts.

The terms “electrolyte” and “electrolyte composition” referred to herein are to be regarded as equivalent with each other and are to be used interchangeably.

It is convenient to express the concentration of the metal-containing salts in terms of its molality in the solvent system; that is, the total number of moles of the metal-containing salts, per 1 kg or 1000 g of the solvent system (i.e., the combined weight of the first component and the second component). Optionally, the concentration of the metal-containing salts is from 0 mol/kg to ≤0.1 mol/kg.

Alternatively, concentrations expressed by “M” (molarity) as disclosed herein relate to the total number of moles of the metal-containing salts, per litre of the solvent system.

Typically, the electrolyte composition is substantially free of one or more metal containing salts. As a metal-containing salt is substantially eliminated from an electrolyte composition according to the present invention, it is generally considered that the toxicity and/or corrosiveness of the composition is suppressed, compared to an electrolyte composition having a metal-containing salt. Indeed, a typical metal-containing salt is generally present in a molal concentration of around 0.5 to 2 m, for instance accounting for 5-35 wt %, preferably 7 to 32 wt % of the total amount of the electrolyte composition, and commonly found metal-containing salts in sodium-ion cells are toxic and/or corrosive as set out below:

### Sodium Hexafluorophosphate (NaPF₆):

Corrosive/Irritant hazards: Skin corrosion, Category 1B, H314
Toxicity hazards: Oral—Category 4, H302; Inhalation, Category 4, H332; Dermal, Category 4, H312
Information taken from Sigma Aldrich Safety Data Sheet Version 6.2; NaPFe; product number 208051.
   Sodium perchlorate (NaClO₄)
Corrosive/Irritant hazards: Eye irritation, Category 2, H319
Toxicity hazards: Oral—Category 4, H302, Specific organ toxicity—repeated exposure, Category 2, Thyroid, H373
Information taken from Sigma Aldrich Safety Data Sheet Version 6.5; NaClO₄; product number 906700.
   Sodium bis(trifluoromethanesulfonyl)imide (NaTFSI)
Corrosive/Irritant hazards: Skin corrosion: Category 1B, H314, Eye irritation: Category 1, H318, May cause respiratory irritation, H335
Information taken from Solvionic Safety Data Sheet Version 8; NaTFSI; product number M1108C.

Furthermore, without the presence of a metal-containing salt (which is a solid at room temperature), the skilled person will understand that the density of the electrolyte composition according to the present invention will be lower than that of an electrolyte composition containing a metal-containing salt because the latter will have a finite amount of solid powder dissolved in the solvent mix, and it is well-known that the density of solids is generally higher than that of liquids. Indeed, FIGS. 4c and 4d of Monti et al, Phys. Chem. Chem. Phys., 2020,22, 22768-22777, clearly show that as the concentration of a metal-containing salt increases, the density of the electrolyte increases, by as much as ~11% between 0.3 M and 2 M for NaTFSI or NaPF₆ systems. The inventors have also observed a similar benefit in lower densities of electrolytes made according to the present invention.

Therefore, as the electrolyte compositions of the present invention are considered lighter (i.e. are of lower density) than existing metal-containing salt electrolyte compositions, this makes the present electrolyte compositions particularly desirable in metal-ion cells and/or anode-free sodium cells for use in mobile (e.g. automotive) or stationary applications.

As evidenced by experimental performance data disclosed herein, the cycling and/or rate performance of the electrolyte compositions of the present invention is considered to be similar, or improved, compared with existing metal-containing salt electrolyte compositions. Thus, the electrolyte compositions of the present invention are not considered to cause secondary environmental impacts through increased fossil fuel usage. Furthermore, removing the need for a salt not only significantly reduces the fabrication cost, but also improves the overall simplicity of the cell functionality.

As disclosed herein, the electrolyte compositions of the present invention are typically substantially free of one or more metal-containing salts. However, to the extent that the electrolyte composition of the present invention contains one or more metal-containing salts, it contains an amount that was previously assumed to not result in any practical benefit in the cycling performance of actual electrochemical cells.

In one embodiment, the conductivity of the electrolyte composition at 25 °C may be less than 3 mS/cm, preferably less than 2.5 mS/cm and more preferably less than 2 mS/cm. Alternatively, the conductivity range at 30 °C may be less than 5 mS/cm.

In one embodiment, the electrolyte compositions of the present invention may contain water in an amount of no greater than about 500 ppm. In one embodiment, the electrolyte compositions of the present invention may contain water in an amount from about 100 ppm to 500 ppm. In some embodiments, the electrolyte compositions of the present invention are substantially free of water.

As used herein, the phrase “metal-containing salt” refers to a metal salt that can impart ionic conductivity to the electrolyte composition.

The second component of the solvent system may comprise or consist essentially of one or more performance additives. The more the one or more performance additives as a second component of the solvent system are preferably selected from sulfur-containing compounds, boron-containing compounds, and surfactants.

The one or more performance additives may be present as a second component of the solvent system in an amount of >0.5 to ≤10% by weight of the solvent system.

One or more of these performance additives as a second component of the solvent system may enable the formation of a stable cathode-electrolyte interphase (CEI) on the cathode and/or a stable solid-electrolyte interphase (SEI) on the anode, or result in other benefits such as improved wetting of the electrolyte on the separator and/or electrode materials by reducing surface tension of the solvent-system and/or surface-adsorption effects which can effectively form artificial SEI/CEI layers, which in turn leads to advantages such as enhanced coulombic efficiencies and enhanced cathode discharge capacity.

Preferably, the one or more performance additives are selected from sulfur-containing compounds which are present as a second component of the solvent system in an amount of >0 to ≤10% by weight of the solvent system.

For the avoidance of any doubt, the phase “weight of the solvent system” as used herein means the weight of the first component of the solvent system combined with the weight of the second component of the solvent system.

The sulfur-containing compounds may be present as a second component of the solvent system an amount of >0.1 to ≤10% by weight of the solvent system, preferably >0.2 to ≤9% by weight of the solvent system, and further preferably >0.3 to 55 wt %. Optionally, the sulfur-containing compounds may be present as a second component of the solvent system in an amount of about 1%, about 2% or about 5% by weight of the solvent system. As a second component, an amount of about 5% by weight of the solvent system is highly preferred.

More preferably, the one or more performance additives are selected from boron-containing compounds which are present as a second component of the solvent system in an amount of >0 to ≤10% by weight of the solvent system.

The boron-containing compounds may be present as a second component of the solvent system in an amount of >0.1 to ≤10% by weight of the solvent system, preferably ≥0.2 to ≤9% by weight of the solvent system, and further preferably 0.3 to ≤5 wt %. Optionally, the boron-containing compounds may be present as a second component of the solvent system in an amount of about 1%, about 2 wt % or about 5% by weight of the solvent system. As a second component, amounts of about 1% or about 5% by weight of the solvent system are highly preferred.

Alternatively, the one or more performance additives are selected from surfactants which are present in as a second component of the solvent system in an amount of >0 to ≤10% by weight of the solvent system.

The surfactants may be present as a second component of the solvent system in an amount of >0.1 to ≤10% by weight of the solvent system, preferably ≥0.2 to ≤9% by weight of the solvent system, and further preferably ≥0.3 to <5 wt %. Optionally, the surfactants may be present as a second component of the solvent system in an amount of about 1%, about 2 wt % or about 5% by weight of the solvent system. As a second component, an amount of about 1% by weight of the solvent system is highly preferred.

The second component of the solvent system may comprise or consist essentially of two or more performance additives. The two or more performance additives may be present as a second component of the solvent system in an amount of >0.5 to ≤10% by weight of the solvent system.

The two or more performance additives as a second component of the solvent system may comprise a mixture of boron-containing compounds and surfactants. That is, one or more boron-containing compounds may be mixed with one or more surfactants to provide a mixture of two or more performance additives.

The two or more performance additives as a second component of the solvent system may comprise a mixture of boron-containing compounds in an amount of >0.5 to <10% by weight of the solvent system and surfactants in an amount of >0.5 to <10% by weight of the solvent system. Optionally, the total amount of the two or more performance additives as a second component of the solvent system does not exceed about 10% by weight based on the weight of the solvent system.

The two or more performance additives as a second component of the solvent system may comprise a mixture of boron-containing compounds in an amount of >1 to <5% by weight of the solvent system and surfactants in an amount of 1 to <5% by weight of the solvent system.

Optionally, the total amount of two or more performance additives as a second component of the solvent system does not exceed about 5% by weight based on the weight of the solvent system.

Alternatively, the two or more performance additives as a second component of the solvent system may comprise a mixture of sulfur-containing compounds and surfactants. That is, one or more sulfur-containing compounds may be mixed with one or more surfactants to provide a mixture of two or more performance additives.

The two or more performance additives as a second component of the solvent system may comprise a mixture of sulfur-containing compounds in an amount of ≥0.5 to <10% by weight of the solvent system and surfactants in an amount of ≥0.5 to <10% by weight of the solvent system. Optionally, the total amount of the two or more performance additives as a second component of the solvent system preferably does not exceed about 10% by weight based on the weight of the solvent system.

The two or more performance additives as a second component of the solvent system may comprise a mixture of sulfur-containing compounds in an amount of 21 to <5% by weight of the solvent system and surfactants in an amount of 1 to <5% by weight of the solvent system.

Optionally, the total amount of the two or more performance additives as a second component of the solvent system does not exceed about 5% by weight based on the weight of the solvent system.

The second component of the solvent system may comprise or consist essentially of three or more performance additives. The three or more performance additives may be present as a second component of the solvent system in an amount of >0.5 to 510% by weight of the solvent system.

The three or more performance additives as a second component of the solvent system may comprise a mixture of:
sulfur-containing compounds;
boron-containing compounds; and
surfactants.

That is, one or more sulfur-containing compounds may be mixed with one or more sulfur-containing compounds, one or more boron-containing compounds, and one or more surfactants to provide a mixture of three or more performance additives.

The three or more performance additives as a second component of the solvent system may comprise a mixture of:
sulfur-containing compounds in an amount of 0.5 to <10% by weight of the solvent system,
boron-containing compounds in an amount of ≥0.5 to <10% by weight of the solvent system, and
surfactants in an amount of ≥0.5 to <10% by weight of the solvent system.

Optionally, the total amount of the three or more performance additives as a second component of the solvent system does not exceed about 10% by weight based on the weight of the solvent system.

The three or more performance additives as a second component of the solvent system may comprise a mixture of:
sulfur-containing compounds in an amount of ≥0.5 to <5% by weight of the solvent system,
boron-containing compounds in an amount of ≥0.5 to <5% by weight of the solvent system, and
surfactants in an amount of ≥0.5 to <5% by weight of the solvent system.

Optionally, the total amount of the three or more performance additives as a second component of the solvent system does not exceed about 5% by weight based on the weight of the solvent system.

The three or more performance additives as a second component of the solvent system may comprise a mixture of:
sulfur-containing compounds in an amount of about 5% by weight of the solvent system, boron-containing compounds in an amount of about 1% by weight of the solvent system, and surfactants in an amount of about 1% by weight of the solvent system.

The total amount of the three or more performance additives as a second component of the solvent system may be about 7% by weight based on the weight of the solvent system.

The three or more performance additives as a second component of the solvent system may comprise (or consist essentially of) a mixture of:
sulfur-containing compounds in an amount of about 2% by weight of the solvent system,
boron-containing compounds in an amount of about 1% by weight of the solvent system, and
surfactants in an amount of about 1% by weight of the solvent system.

The total amount of the three or more performance additives as a second component of the solvent system may be about 4% by weight based on the weight of the solvent system.

The one or more non-aqueous solvents as a first component of the solvent system are preferably selected from organo phosphate-based solvents, organo carbonate-based solvents, and glyme-based solvents.

The one or more organo phosphate-based solvents present as a first component of the solvent system of the present invention may be defined as described herein.

The one or more organo phosphate-based solvents present as a first component of the solvent system may be cyclic or non-cyclic compounds.

The one or more organo phosphate-based solvents as a first component of the solvent system are characterised by the fact that they contain a phosphate ester group, i.e. a phosphorous atom that is 1) doubly bonded to an oxygen atom, and 2) singly bonded to three other oxygen atoms, which are further singly bonded to one or more carbon atoms.

The general formula of such compounds is R₃(PO)₄ in which R may be the same or vary in each individual attachment case.

A preferred general formula of such compounds is RR′R″(PO₄) in which:
R, R′, and R″ may be independently selected from any straight or branched, substituted or unsubstituted C₁ to C₆-alkyl group; a straight or branched, substituted or unsubstituted C₁ to C₆-alkenyl group; a straight or branched, substituted or unsubstituted C₁ to C₆-alkoxy group; or a substituted or unsubstituted C₃-C₆-cycloalkyl-, phenyl- or heterocycle-containing group.

Highly suitable electrolyte solvents as a first component of the solvent system include C₁-C₁₀ alkyl organo phosphates, such as triethyl phosphate.

Preferred electrolyte compositions of the present invention include a first component which comprises one or more organo phosphate-based solvents that are present in an amount of about 50% by weight or more, further preferably about 70% by weight or more, further more preferably about 90% by weight or more, and most preferably about 95% by weight or more of the organo phosphate-based solvent (i.e., the first component of the solvent system). One such example may include a first component which comprises triethyl phosphate in an amount of about 90% by weight or more of the first component of the solvent system.

Highly preferred electrolyte compositions of the present invention include a first component which consists essentially of one or more organo phosphate-based solvents, and ideally, triethyl phosphate.

The one or more organo carbonate-based solvents present as a first component of the solvent system of the present invention may be defined as described herein.

The one or more organo carbonate-based solvents present as a first solvent component, may be cyclic or non-cyclic compounds that are characterised by the fact that they contain a carbonate ester group, i.e. a carbonyl group that is flanked by one or two alkoxygroups: R₁O(C═O)OR₂. The R, and R₂ groups are preferably independently selected (i.e. they may be the same or different from each other) from either hydrogen; or a C₁ to C₂₀-cyclic or non-cyclic, branched or unbranched, substituted or unsubstituted alkyl group; or a C₁ to C₂₀-cyclic or non-cyclic, branched or unbranched, substituted or unsubstituted alkenyl group; or a C₁ to C₂₀-branched or unbranched, substituted or unsubstituted cycloalkyl-, phenyl- or heterocycle-containing group.

Highly suitable electrolyte solvents include C₃-C₁₀ cycloalkyl organo carbonates, such as propylene carbonate (C₄H₆O₃) and ethylene carbonate (C₃H₄O₃). Propylene carbonate (PC) (C₄H₆O₃) shows particularly favourable compatibility with electrode materials and the high solubility, wide liquidus range and a high boiling point of this material also makes this solvent advantageous for use in metal-ion batteries, particularly sodium-ion batteries. Other highly suitable organo carbonate-based compounds include diethyl carbonate (DEC), dimethyl carbonate (DMC), ethylene carbonate (EC), ethyl methyl carbonate (EMC), fluoroethylene carbonate (FEC) and vinylene carbonate (VC). Propylene carbonate (PC), diethyl carbonate (DEC), and ethylene carbonate (EC) are especially preferred.

Preferred electrolyte compositions of the present invention include a first component which comprises organo carbonate-based solvents that are present in an amount of at least 50% by weight, further preferably at least 70% by weight, furthermore preferably at least 90% by weight, and most preferably at least 95% by weight of the organo carbonate-based solvents (i.e., the first component of the solvent system).

One electrolyte composition of the present invention may include a first component which comprises a mixture of propylene carbonate in combination with one or more further organo carbonate-based compounds. Ideally, propylene carbonate is mixed with diethyl carbonate (DEC), preferably in which diethyl carbonate (DEC) is present in an amount of about 20 wt % by weight of the first component of the solvent system.

An alternative highly preferred electrolyte composition of the present invention may include a first component which contains a mixture of ethylene carbonate (EC), diethyl carbonate (DEC) and propylene carbonate (PC), and this would ideally be in the weight ratio range 1 to 4:1 to 10:1 to 10 wt/wt and further ideally in the weight ratio 1 to 2:1 to 5:1 to 2 wt/wt, and most preferably in the weight ratio 1:2:1 wt/wt.

An alternative preferred electrolyte composition of the present invention may comprise a mixture of ethylene carbonate (EC) and dimethyl carbonate (DMC). These organo carbonate-based components are preferably present in the weight ratio 1 to 20:1 to 20 wt/wt, further preferably in the weight ratio 1 to 10:1 to 10 wt/wt, also preferably 1 to 5:1 to 5 wt/wt, and most preferably in the weight ratio 1:1 wt/wt.

Another electrolyte composition of the present invention may include a first component which comprises a mixture of one or more organo phosphate-based solvents in combination with one or more organo carbonate-based compounds.

Ideally triethyl phosphate is mixed with fluoroethylene carbonate (FEC), preferably in which fluoroethylene carbonate (FEC) is present in an amount of about 10 wt % by weight of the first component of the solvent system.

Alternatively, triethyl phosphate is mixed with vinylene carbonate (VC), preferably in which vinylene carbonate (VC) is present in an amount of about 3 wt % by weight of the first component of the solvent system.

The one or more glyme-based solvents present as a first component of the solvent system of the present invention may be defined as described herein.

The one or more glyme-based solvents present in the first component i) may be saturated non-cyclic polyethers preferably containing no other functional groups. Glymes are also known as glycol diethers.

Highly suitable glyme-based solvents may be selected from ethylene glycol dimethyl ether (monoglyme), diethylene glycol dimethyl ether (diglyme), triethylene glycol dimethyl ether (triglyme) and tetraethylene glycol dimethyl ether (tetraglyme). Diethylene glycol dimethyl ether (diglyme) and tetraethylene glycol dimethyl ether (tetraglyme) are especially preferred glyme-based solvents.

When a mixture of glyme-based compounds is used, it is convenient to express the amount of each of the one or more glyme-based solvents in terms of a weight ratio. For example, as discussed above, a highly preferred glyme-based solvent might contain a mixture of diglyme and tetraglyme present as a first component of the solvent system, and this would ideally be in the weight ratio 1 to 20:1 to 20 wt/wt, further preferably in the weight ratio 1 to 10:1 to 10 wt/wt, also preferably 1 to 5:1 to 5 wt/wt, and most preferably in the weight ratio 1:1 wt/wt.

Preferred electrolyte compositions of the present invention include a first component which comprises a mixture of diglyme and tetraglyme. Ideally, diglyme is present in an amount of about 50% by weight of the first component of the solvent system, and tetraglyme is present in an amount of about 50% by weight of the first component of the solvent system. Thus, the total amount of diglyme and tetraglyme is preferably about 100% by weight of the first component of the solvent system.

As discussed above, the second component of the solvent system according to the present invention may include one or more surfactants. The one or more surfactants of the present invention may be defined as described herein.

The total amount of the one or more surfactants used in the second component of the solvent system of the present invention, maybe >0.2 to <20% by weight of the solvent system, preferably 0.2 to <10% by weight of the solvent system, further preferably ≥0.2 to ≤4% by weight, very preferably ≥0.5 to ≤3% by weight and ideally 0.5 to ≤2.5% by weight, based on the total weight of the electrolyte solvent system used in the electrolyte composition.

The amount of the one or more surfactants used in the second component of the electrolyte composition according to the present invention, maybe >0% by weight of the solvent system, ideally >0.2% by weight of the solvent system, preferably >0.5% by weight, based on the total weight of the electrolyte solvent system used in the electrolyte composition.

The one or more surfactants used in the second component of the solvent system according to the present invention are performance additives and are preferably selected to enhance the ability of the electrolyte composition to wet the separator (particularly a polyolefin separator) and/or the electrode of the battery which, in turn, advantageously promotes a longer battery cycle life. Furthermore, it is known in the literature that surfactants, by virtue of their surface-adsorption on different substrates, can lead to non-dendritic metal plating/stripping (and also inhibit corrosion). Preferred one or more surfactant additives are selected from anionic surfactants, cationic surfactants, non-ionic (hydrophilic) surfactants and amphoteric (zwitterionic) surfactants, with anionic surfactants and non-ionic (hydrophilic) surfactants being especially preferred. Such surfactants additives are ideally one or more selected from:
1) anionic (negatively charged) surfactants. Suitable examples include: carboxylates (such as alkyl carboxylates (e.g. fatty acid salts)), carboxylate fluoro-surfactants; sulfates (such as alkyl sulfates (e.g. sodium lauryl sulfate), alkyl ether sulfates (e.g. sodium laureth sulfate)); sulfonates (such as docusates (e.g. dioctyl sodium sulfosuccinate) and alkyl benzene sulfonates); and phosphate esters (such as alkyl aryl ether phosphates and alkyl ether phosphates (e.g. trioctyl phosphate);
2) Zwitterionic (amphoteric) surfactants, which can be anionic, cationic or non-ionic depending on the pH of the solution they are in. Examples include: RN⁺H₂CH₂COO⁻, RN⁺(CH₃)₂CH₂CH₂SO₃—, phospholipids (such as phosphatidylcholine (lecithin));
3) Cationic surfactants which bear a positive charge for example RN⁺H₃Cl⁻, RN⁺(CH₃)₃Cl⁻, diotadecyldimethylammonium chloride, cetyl pyridinium chloride, benzalkonium chloride, hexadecyl trimethylammonium chloride (CTAC) and hexadecyl trimethylammonium bromide (CTAB); and
4) Non-ionic surfactants. These are uncharged, and examples include: polyol esters (e.g. glycol, glycerol esters, sorbitan and sorbitan derivatives such as fatty acid esters of sorbitan (Spans) and their ethoxylated derivatives (Tweens)), polyoxyethylene esters and poloxamers which comprise block copolymers, for example Poloxamer 84, Poloxamer 105, Poloxamer 123, Poloxamer 124, Poloxamer 188, Poloxamer 237, Poloxamer 338, Poloxamer 407 and Poloxamer F127.

Most preferably, the one or more surfactants used in the second component of the solvent system according to the present invention contain one or more non-ionic block copolymer-containing surfactants. Highly suitable examples include poloxamers. A very specific example includes Poloxamer 123.

As discussed above, the second component of the solvent system according to the present invention may include one or more sulfur-containing compounds. The one or more sulfur-containing compounds of the present invention may be defined as described herein.

The one or more sulfur-containing compounds used in the second component of the solvent system according to the present invention are performance additives, and are preferably selected to enable the formation of a stable cathode-electrolyte interphase (CEI) on the cathode and/or a stable solid-electrolyte interphase (SEI) on the anode, which in turn leads to advantages such as enhanced 1st cycle coulombic efficiencies (FCE=first cycle coulombic efficiency) and cycle life enhancement; alternatively, the additive might decompose significantly preferentially in the first cycle, which might lead to a low first cycle efficiency, but then improves subsequent cycling stability.

Suitable sulfur-containing compounds may include cyclic and/or non-cyclic sulfur-containing compounds.

Preferably, the sulfur-containing compound is a sulfone-containing compound, a sulfate-containing compound, or a sulfonate-containing compound.

In other words, the sulfur-containing compound may have a sulfonyl functional group which is attached to: two carbon atoms (sulfone), two oxygen atoms (sulfate), or one carbon atom and one oxygen atom in a cyclic or non-cyclic structure (sulfonate). When the sulfonate is cyclic, the compound may be referred to as a sultone.

As used herein the term “sulfone” means that the central hexavalent sulfur atom is doubly-bonded to each of two oxygen atoms and has a single bond to each of two carbon atoms.

As used herein the term “sulfate” means that the central hexavalent sulfur atom is doubly-bonded to two of the oxygen atoms and has a single bond to the other two oxygen atoms, which are each further singly bonded to carbon atoms.

As used herein the term “sulfonate” means that the central hexavalent sulfur atom is doubly-bonded to two of the oxygen atoms; it has a single bond to one carbon atom; and a single bond to the other oxygen atom, which is further singly bonded to a carbon atom, which if cyclically connected to the other carbon atom bonded to the sulfur atom, would be a sultone.

The general formula of such compounds is RY(S═O)₂Y′R′, in which:
Y and Y′ is independently selected from C or O (i.e. they may be the same or different from each other);
when Y and Y′ are the same, R and R′ may be independently selected (i.e. they may be the same or different from each other) from any straight or branched, substituted or unsubstituted C₁ to C₆-alkyl group; a straight or branched, substituted or unsubstituted C₁ to C₆-alkenyl group; a straight or branched, substituted or unsubstituted C₁ to C₆-alkoxy group; or wherein R and R′ may independently or together form a substituted or unsubstituted C₃-C₆-cycloalkyl-, phenyl- or heterocycle-containing group; and
when Y and Y′ are different from each other, R′ may be independently selected from any straight or branched, substituted or unsubstituted C₁ to C₆-alkyl group; a straight or branched, substituted or unsubstituted C₁ to C₆-alkenyl group; a straight or branched, substituted or unsubstituted C₁ to C₆-alkoxy group; or wherein R and R′ may independently or together form a substituted or unsubstituted C₃-C₆-cycloalkyl-, cycloalkenyl-, phenyl- or heterocycle-containing group.

In some embodiments, the general formula of such compounds is R—SO₂—R′, in which R and R′ may be independently selected (i.e. they may be the same or different from each other) from any straight or branched, substituted or unsubstituted C₁ to C₆-alkyl group; a straight or branched, substituted or unsubstituted C₁ to C₆-alkenyl group; a straight or branched, substituted or unsubstituted C₁ to C₆-alkoxy group; or wherein R and R′ may independently or together form a substituted or unsubstituted C₃-C₆-cycloalkyl-, phenyl- or heterocycle-containing group.

Preferably, the general formula of such compounds is RO(S═O)₂OR′, in which R and R′ may be independently selected (i.e. they may be the same or different from each other) from any straight or branched, substituted or unsubstituted C₁ to C₆-alkyl group; a straight or branched, substituted or unsubstituted C₁ to C₆-alkenyl group; a straight or branched, substituted or unsubstituted C₁ to C₆-alkoxy group; or wherein R and R′ may independently or together form a substituted or unsubstituted C₃-C₆-cycloalkyl-, phenyl- or heterocycle-containing group.

Highly preferably, the sulfur-containing compound is selected from a cyclic sulfate (such as 1,3-propanediolcyclic sulfate (PCS) also known as 1,3,2-Dioxathiane 2,2-dioxide (DTD or (CH₂)₃SO₄))); 1,5,2,4-dioxadithiane 2,2,4,4-tetraoxide; or 1,3,2-Dioxathiolane 2,2-dioxide.

Suitable examples of cyclic sulfones include: sulfolane ((CH₂)₄SO₂), 3-methyl sulfolane ((CH₃)CH(CH₂)₃SO₂),), and trimethyl sulfone ((CH₂)₃SO₂). Suitable examples of non-cyclic sulfones include: methyl phenyl sulfone ((CH₃)(C₆H₅)SO₂).

Suitable examples of examples of sultones include: 1-propene 1,3-sultone ((CH)₂CH₂SO₃), and 1,3-propane sultone (CH₂)₃SO₃,

Most preferably, the sulfur-containing compound is 1,3-propanediolcyclic sulfate (PCS).

The total amount of the one or more sulfur-containing compounds used in the second component of the solvent system according to the present invention, is >0.5 to ≤10% by weight of the solvent system, preferably ≥0.6 to ≤6% by weight of the solvent system, further preferably ≥0.6 to ≤4% by weight, very preferably ≥0.6 to ≤3% by weight and ideally 0.6 wt % to ≤2.5% by weight, based on the total weight of the electrolyte solvent system used in the electrolyte composition.

The amount of the one or more sulfur-containing compounds used in the second component of the solvent system according to the present invention, maybe >0% by weight of the solvent system, ideally >0.2% by weight of the solvent system, preferably >0.5% by weight, based on the total weight of the electrolyte solvent system used in the electrolyte composition.

In one embodiment, the sulfur-containing compound as a performance additive according to the present invention does not include dimethyl sulfoxide (DMSO).

As discussed above, the second component of the solvent system according to the present invention may include one or more boron-containing compounds. The one or more boron-containing compounds of the present invention may be defined as described herein.

The boron-containing compounds used in the second solvent component of solvent system according to the present invention are performance additives, and are preferably selected to enable the formation of a stable cathode-electrolyte interphase (CEI) on the cathode and/or a stable solid-electrolyte interphase (SEI) on the anode, which in turn leads to advantages such as enhanced 1st cycle coulombic efficiencies and/or cycle life enhancement.

Suitable boron-containing compounds may include cyclic and/or non-cyclic boron-containing compounds.

Preferably, the one or more boron-containing compound is a borate or a boroxine.

In other words, the one or more boron-containing compounds may have a central boron atom which is attached to three oxygen atoms, which are each further singly bonded to carbon or silicon atoms (borate). Or the one or more boron-containing compounds may comprise a 6 membered heterocyclic structure which is composed of three alternating boron atoms and oxygen atoms joined together by a shared single bond. Each boron atom is further singly bonded to a carbon atom or oxygen external to the heterocyclic structure.

As used herein the term “borate” means that the central trivalent boron atom is singly bonded to three oxygen atoms, which are each further singly bonded to carbon or silicon atoms.

As used herein the term “boroxine” means a 6 membered heterocyclic compound that is composed of singly bonded alternating trivalent boron atoms and divalent oxygen atoms, each boron atom being further singly bonded to an oxygen or carbon atom external to the heterocyclic structure.

The general formula of such borate compounds is B(OYR)₃, in which Y and R may be the same or vary in each individual attachment case. More specifically this may be written as:

B(OYR)(OY′R′)(OY″R″), in which
Y, Y′, and Y″ is independently selected from C or Si (i.e. they may be the same or different from each other); and
R, R′, and R″ may be independently selected from hydrogen; any straight or branched, substituted or unsubstituted C₁ to C₆-alkyl group; a straight or branched, substituted or unsubstituted C₁ to Ce-alkenyl group; a straight or branched, substituted or unsubstituted C₁ to C₆-alkoxy group; or a substituted or unsubstituted C₃-C₆-cycloalkyl, phenyl- or heterocycle-containing group.

Further preferably, the boron-containing compound is selected from a non-cyclic borate.

Suitable examples include tris(trimethylsilyl) borate (TMSB);
Tris(2,2,2-trifluoroethyl) borate;
Trimethyl borate; and
Triethyl borate

The general formula of such boroxine compounds is B₃(YR)₃O₃, in which Y and R may be the same or vary in each individual attachment case. More specifically, this may be written as:

Bₐ(YR)_{b}(O)_{c}, in which
Y is independently selected from C or O (i.e. they may be the same or different from each other); and
R may be the same or vary in each individual attachment case and may be independently selected from hydrogen; any straight or branched, substituted or unsubstituted C₁ to C₆-alkyl group; a straight or branched, substituted or unsubstituted C₁ to C₆-alkenyl group; a straight or branched, substituted or unsubstituted C₁ to C-alkoxy group; or a substituted or unsubstituted C₃-C₆-cycloalkyl-, phenyl- or heterocycle-containing group; and
a=b=c, wherein a, b, and c are each 3.

Suitable examples include:
Trimethoxyboroxine; and
Trimethylboroxine

Most preferably, the boron-containing compound is tris(trimethylsilyl) borate (TMSB).

The total amount of the one or more boron-containing compounds used in the second component of the solvent system according to the present invention, is >0.5 to ≤10% by weight of the solvent system, preferably ≥0.6 to ≤6% by weight of the solvent system, further preferably ≥0.6 to ≤4% by weight, very preferably ≥0.6 to ≤3% by weight and ideally 0.6 wt % to ≤2.5% by weight, based on the total weight of the electrolyte solvent system used in the electrolyte composition.

The amount of the one or more boron-containing compounds used in the second component of the solvent system according to the present invention, maybe >0% by weight of the solvent system, ideally >0.2% by weight of the solvent system, preferably >0.5% by weight, based on the total weight of the electrolyte solvent system used in the electrolyte composition.

The electrolyte composition according to the present invention may further comprise one or more additional compounds which may or may not be a solvent.

Examples of such additional compounds include: a flame retardant compound (such as a polyalkly phosphate-containing compound, preferably a non-fluorinatedpolyalkyl phosphate-containing compound), a diluent (such as a hydrofluoroether-containing compound, preferably a hydrofluoroalkyl ether-containing compound), a glycol ether acetate, an ionic liquid, and any solvent which is capable of promoting the reduction of viscosity of the electrolyte by acting as an inert diluent (such as a hydrofluoroalkyl ether, preferably 1,1,2,2-Tetrafluoroethyl-2,2,3,3-tetrafluoropropyl ether (HFE or TTE)).

The electrolyte composition according to the present invention may also optionally include one or more further performance additives, typically an amount of <15% by weight, preferably <10% by weight and further preferably 0.1 wt % to <5% by weight, of the total weight of the solvent system used in the electrolyte composition. Such performance additives preferably act at the electrolyte-electrode interface rather than in the bulk of the electrolyte, such as tris(trimethylsilyl) phosphite, or tris (trimethylsilyl) phosphate.

Suitable further performance additives may be selected from: polymerizable additives for promoting overcharge protection such as biphenyl, diphenylamine, dimethoxydiphenylsilane (DDS), 3-chloroanisole (3CA), N-phenylmaleimide, xylene (methyl-substituted benzene) and cyclohexylbenzene; additives for promoting overcharge protection based on redox-shuttle mechanism such as 2,5-di-tert-butyl-1,4 dimethoxybenzene (DDB), 4-tert-butyl-1,2-dimethoxybenzene (TDB), 1,4 bis(trimethylsilyl)-2,5-dimethoxybenzene (BTMSDB) and 1,4-bis(2-methoxyethoxy)-2,5 di-tert-butylbenzene; additives for imparting further flame retardancy attributes to the electrolyte such as dimethyl methylphosphonate (DMMP), ethoxy-pentafluoro-cyclotriphosphazene (N3P3F5OCH2CH3, EFPN), tri(2,2,2-trifluoroethyl) phosphite and/or tri(2,2,2-trifluoroethyl) phosphate (TFEP), methyl nonafluorobuyl ether (MFE) and silane-Al2O3 nanoparticles; additives for promoting better high temperature cycling such as succinic anhydride; and additives for rendering inert unwanted decomposition products (such as HF, water or CO2) in-situ, such as zeolites.

The electrolyte composition according to the present invention may further comprise one or more non-metal supporting electrolyte salts, referred to herein as “supporting salts”. For the purposes of this disclosure, a “supporting salt” is any salt that is not a metal containing salt yet facilitates the transfer of the metal cation (i.e. Na⁺) from the cathode to the anode and vice versa. The non-metal supporting salt however, does not take part in the electrochemical process of the electrochemical cell.

Highly preferably, the non-metal supporting salt may be selected from one or more quaternary ammonium salts, wherein a nitrogen atom is singly bonded to four alkyl groups to form a soluble cationic compound. Suitable non-metal supporting salts include tetrabutylammonium hexafluorophosphate (TBAPF₆) and tetraethylammonium hexafluorophosphate (TEAPF₆).

Preferably, the non-metal supporting salt is tetrabutylammonium hexafluorophosphate (TBAPF₆).

It is convenient to express the concentration of the one or more non-metal supporting salts in terms of its molality (m) in the solvent system; that is, the total number of moles of the one or more non-metal supporting salts (i.e. solute), per kilogram or 1000 g of the solvent system (i.e. the combined weight of the first component and the second component). Preferably, the molality of each of the non-metal supporting salts individually in a) is in the range 0.1 mol/kg to 5 mol/kg, and further preferably in the range 0.1 mol/kg to ≤2.5 mol/kg. Highly preferably, particularly when the non-metal supporting salt is TBAPF₆, the molality is in the range 0.1 mol/kg to ≤2.5 mol/kg, and most preferably about 1.0 mol/kg.

The electrolyte compositions of the present invention are especially useful in an electrochemical cell, preferably in a sodium-based electrochemical cell. Thus, in a further aspect, the present invention provides an electrochemical cell comprising an electrolyte composition as defined herein. A preferred electrochemical cell includes a metal ion cell (e.g., a sodium-ion cell), an anode-free cell (e.g. a sodium anode-free cell), and an alkali metal cell (e.g. a sodium metal cell).

The electrolyte compositions of the present invention are especially useful in metal-ion cells.

Thus, in a further aspect, the present invention provides a metal-ion cell comprising a negative electrode, a positive electrode and an electrolyte composition as defined herein. The metal-ion cell of the present invention may be selected from an alkali metal cell and a non-alkali metal cell.

When an alkali metal cell is used, it preferable that the alkali metal cell is selected from one or more of a sodium-ion cell, lithium-ion cell and potassium-ion cell. Preferably, the alkali metal cell is selected from one or more of a sodium-ion cell, lithium-ion cell, and potassium-ion cell.

Most preferably, the alkali metal cell is a sodium-ion cell. When a non-alkali metal-ion cell is used, it is preferable that the non-alkali metal-ion cell is a zinc-ion cell, an aluminium-ion cell, a calcium-ion cell or a magnesium-ion cell.

The metal-ion cells of the present invention may use a negative electrode (anode) which comprises negative active materials that are commonly used in the art. For example, the negative electrode (anode) which comprises a negative active material may be one or more of graphite material, soft carbon, hard carbon, carbon fibers, mesocarbon microbeads, silicon-based material, tin-based material, P-based material, Sb-based material, SnSb-based material, other types of materials that store charge via a conversion and/or alloying-type reaction (such as simple/binary/ternary etc oxides of Fe, Cu, Ni, Mn etc) and materials that store charge via a classical intercalation-type reaction such as lithium titanium oxide, different types of sodium titanates, titania etc; along with any combination of one or more of these preceding materials such as carbon/Sb, carbon/P, carbon/Fe₂O₃, either as mixtures generated by physical blends (such as carbon and Sb blended together by physical or chemical mixing methods such as ball-milling or spray-drying) or via an in-situ reaction (via an appropriate synthesis route such as solvo/hydrothermal, sol-gel, solution-based, reflux, co-precipitation, or solid-state reaction with or without subsequent heating/pyrolysis steps), the latter of which might result also result in doped materials (such as doped carbon with Sb or P or Sn) and/or substituted materials (such as substitution of Fe₂O₃ with a bit of TiO₂).

The metal-ion cells disclosed herein may include a separator located between the cathode and the anode current collector. A polyolefin separator is preferable. Ideally, the thickness of the polyolefin separator is 25 μm or less. It is preferable that the thickness is 16 μm or less.

The metal-ion cells of the present invention may be used in an energy storage device, for example a battery, a rechargeable battery, an electrochemical device and an electrochromic device.

Specifically, when the metal-ion cell is a sodium-ion or potassium-ion cell, the sodium-ion or potassium-ion cell may use a negative electrode (anode) which comprises a negative active material whose structure is adapted to allow the insertion/removal of sodium or potassium ions during charge/discharge. Preferably, a carbon-containing material may be employed as the negative active material. Highly preferably, the negative active material may be a non-graphitisable carbon-containing material, and most preferably a hard carbon-containing material. A suitable hard carbon negative active material includes Kuranode Type 1, supplied by Kureha.

Specifically, when the metal-ion cell is a sodium-ion cell, the sodium-ion cell may comprise a positive electrode (cathode) which comprises any sodium-containing positive electrode active material which is adapted to allow the insertion/removal of sodium ions during charge/discharge. Examples of these include sodium transition metal oxides, polyanionic compounds (including fluorinated polyanionic compounds), Prussian blue analogue (PBA) compounds (such as Prussian White or Berlin Green), materials storing sodium via a conversion reaction, sodium transition metal fluorides, oxyfluorides, phosphates, sulfates, and silicates (and their fluorinated versions). Preferred examples are sodium transition metal oxides.

Preferred sodium transition metal oxides are of the general formula:

A_{1±δ}M¹_{V}M²_{W}M³_{X}M⁴_{Y}M⁵_{Z}O_{2-c}
wherein
A is one or more alkali metals selected from sodium, potassium and lithium;
M¹ comprises one or more redox active metals in oxidation state +2, preferably selected from
the group consisting of nickel, copper, cobalt and manganese;
M² comprises a metal in oxidation state greater than 0 to less than or equal to +4;
M³ comprises a metal in oxidation state +2;
M⁴ comprises a metal in oxidation state greater than 0 to less than or equal to +4;
M⁵ comprises a metal in oxidation state +3;
wherein
0≤δ≤1;
V is >0;
W is ≥0;
X is ≥0;
Y is ≥0;
at least one of W and Y is >0
Z is ≥0;
C is in the range 0≤c<2
wherein V, W, X, Y, Z and C are chosen to maintain electrochemical neutrality.

Ideally, metal M² comprises one or more transition metals, and is preferably selected from manganese, titanium and zirconium; M³ is preferably one or more selected from magnesium, calcium, copper, tin, zinc and cobalt; M⁴ comprises one or more transition metals, preferably selected from manganese, titanium and zirconium; and M⁵ is preferably one or more selected from aluminium, iron, cobalt, tin, molybdenum, chromium, vanadium, scandium and yttrium.

A particularly preferred positive electrode active material for use in a sodium-ion cell will be a nickelate-based material. A sodium-containing active material with any crystalline structure may be used, however, preferably the structure will be O3 or P2 or a derivative thereof, but, specifically, it is also possible that the cathode electrode active material will comprise a mixture of phases, i.e. it will have a non-uniform structure composed of several different crystalline forms. For example, the cathode active material will comprise a compound with the general formula detailed above in a mixture of O3 and P2 phases. The ratio of 03:P2 phases is preferably 1 to 99:99 to 1.

Specifically, when the metal-ion cell is a potassium-ion cell, the potassium-ion cell may comprise a positive electrode (cathode) which comprises any potassium-containing positive electrode active material which is adapted to allow the insertion/removal of potassium ions during charge/discharge. Examples of these include oxide-based materials, phosphate and/or fluorophosphate-based materials or PBA compounds. A particularly preferred potassium-containing positive electrode active material is P3-type K_{0.5}[Mn_{0.5}Fe_{0.1}Ni_{0.1}]O₂ layered oxide, K₂MnFe(CN)₆ or KVPO₄F.

Specifically, when the metal-ion cell is a lithium-ion cell, the lithium-ion cell may use a negative electrode which comprises a negative active material whose structure is adapted to allow the insertion/removal of lithium ions during charge/discharge. Preferably, a carbon-containing material is employed as the active negative electrode material. Highly preferably, the carbon-containing material is a graphitisable carbon-containing material, and most preferably a graphite-containing material. A suitable graphite negative active material includes graphite supplied by MTI.

Specifically, when the metal-ion cell is a lithium-ion cell, the lithium-ion cell may comprise a positive electrode (cathode) which comprises any lithium-containing positive electrode active material which is adapted to allow the insertion/removal of lithium ions during charge/discharge. Examples of these include lithium cobalt oxide, lithium nickel oxide, lithium manganese oxide, lithium nickel manganese oxide, lithium nickel cobalt manganese oxide, lithium nickel cobalt aluminum oxide (NCA), transition metal phosphate, and lithium iron phosphate. A particularly preferred lithium-containing positive electrode active material is LiNi_{0.5}Co_{0.2}Mn_{0.3}O₂(NCM523), LiNi_{0.8}Co_{0.1}Mn_{0.1}O₂(NCM811) or NCA.

The present invention also provides in another aspect the use of an electrolyte composition as defined herein in metal-ion cell. Such metal-ion cells may be defined as set out above.

The electrolyte compositions of the present invention are also especially useful in anode-free sodium cells, also called an in-situ sodium plated cells. Such anode-free sodium cells may be used in an energy storage device, for example a battery, a rechargeable battery, an electrochemical device and an electrochromic device.

Thus, in a further aspect, the present invention provides an anode-free sodium cell comprising an electrolyte composition as defined herein. More particularly, in one aspect, the present invention provides:
an anode-free sodium cell comprising:
a cathode comprising one or more sodium-containing active materials;
an anode current collector;
a separator located between the cathode and the anode current collector; and
an electrolyte composition as defined herein.

The present invention also provides in another aspect the use of an electrolyte composition as defined herein in an anode-free sodium cell.

As used herein an “anode-free sodium cell” refers to a cell in which the working principle of the cell involves sodium metal cation (Na⁺) extraction/insertion from the cathode active material, and sodium metal (Na) deposition and plating/removal and stripping at the anode current collector. During a first charge cycle of an anode-free sodium cell, a sodium metal anode is formed in situ on the anode current collector as sodium metal cations are reduced and deposit on the anode current collector as sodium metal.

When the anode-free sodium cell is fully discharged, the anode current collector includes only an insignificant amount of sodium metal or substantially less sodium metal than the case of a fully charged cell, with the majority of the sodium metal having been oxidised to form sodium metal cations that are present in the electrolyte and/or stored in the cathode. When the anode-free sodium cell is fully charged, the anode current collector includes a layer of sodium in electrical contact with the anode current collector, with correspondingly less amount of the sodium in the cathode. The layer of sodium in electrical contact with the anode current collector may be across the entire surface of the anode current collector, or it may be deposited in some regions of the anode current collector. However, where the sodium is deposited, it is preferable for any such sodium layer to be uniform and homogenous.

The anode-free cell disclosed herein may include a separator located between the cathode and the anode current collector. A polyolefin separator is preferable.

The cathode typically comprises a sodium-containing active material which is disposed on one or more surfaces of a (cathode) current collector. The cathode current collector and the anode current collector can each be independently fabricated from any suitable conductive material. For example, the cathode current collector, the anode current collector, or both the cathode current collector and the anode current collector can be formed from a metal; such as nickel, aluminium, titanium, copper, gold, silver, platinum, aluminium alloy, stainless steel or any other metal substrate (similar to the current collectors that are generally used in sodium-ion batteries currently).

The cathode current collector, the anode current collector, or both the cathode current collector and the anode current collector can be formed from aluminium or aluminium alloy (e.g., an alloy of aluminium and one or more of Mg, Mn, Cr, Zn, Si, Fe, and Ni). Highly preferably, both the cathode current collector and the anode current collector comprise an aluminium current collector. Alternatively, copper, magnesium, carbon paper/foil/substrate and tin might also be used as current collector materials.

The cathode current collector and the anode current collector can be formed into any suitable shape compatible with the overall design of the electrochemical cell. For example, the cathode current collector and the anode current collector can each independently be formed as a foil, flat plate, mesh, net, lath, perforated metal or emboss, or a combination of these shapes (for example, meshed flat plate). If desired, irregularities may be formed on one or more surfaces of the cathode current collector and/or the anode current collector, for example, by etching the one or more surfaces of the current collector. Highly preferably, the anode current collector is formed from aluminium or aluminium alloy, and comprises a foil or mesh shape.

Preferably, the anode current collector also includes one or more nucleation layers formed on one or more surfaces of the anode current collector, prior to an initial first charge cycle of the anode-free sodium cell. Highly preferably, such one or more nucleation layers comprise one or more carbon-containing nucleation layers. As the anode current collector is formed with one or more nucleation layers on one or more surfaces of the anode current collector, during a first charge cycle of the anode-free sodium cell, metal cations are reduced and deposit on the one or more nucleation layers as sodium metal. The surface of the current collector or the nucleation layer can also be pre or post coated with either sodium or other materials and physical vapour deposition is useful means of achieving such coatings

As used herein the term “nucleation layer” means any coating or layer that is disposed on one or more surfaces of a “pristine” anode current collector prior to an initial first charge cycle of the anode-free sodium cell. The use of a nucleation layer enables a more uniform and homogeneous sodium metal deposition, compared to a current collector without such a nucleation layer. A particularly preferred nucleation layer is any coating or layer that will result in a decrease of the “nucleation overpotential” of sodium metal plating.

As sodium metal is deposited on an anode current collector via constant-current (galvanostatic) cycling, the potential of sodium plating will first decrease (to a more negative value below 0 V vs Na/Na⁺), before rising to a higher potential value (but still below 0 V vs Na/Na⁺) during steady-state conditions for the same galvanostatic current values.

Thus, the “nucleation overpotential” of sodium deposition is defined herein as the difference between the most negative potential and the steady-state plating potential. Therefore, a person skilled in the art could readily measure the nucleation overpotential of sodium deposition using an anode current collector that includes one or more nucleation layers formed on a surface of the anode current collector and compare it to the nucleation overpotential of sodium deposition using a “pristine” anode current collector to determine a preferred nucleation layer described herein. This could be performed in a half-cell or three-electrode cell constructed using the common general knowledge.

As discussed above, advantageously, the one or more nucleation layers enable the deposition of sodium metal atoms and clusters of atoms at and across the surface of the anode current collector, and thus facilitates more uniform plating whilst also minimising parasitic reactions.

The one or more nucleation layers may be formed across the majority (or the entire 100%) of the one or more surfaces of the anode current collector, or may be formed as a partial coating by design (e.g. one or more nucleation layers formed on some regions of such surfaces—these regions would be homogenous and uniform within the area). The one or more nucleation layers preferably comprises one or more layers of negative active material (e.g., a thin layer such as from 0.1 μm to 1000 μm) which may or may not be mixed with any type of conductive additive such as carbon black (to enhance the electronic conductivity of the negative active material) and/or a binder material which can be compatible with a water or organic solvent).

Highly preferably, the one or more nucleation layers comprise one or more carbon-containing nucleation layers, and highly preferably one or more carbon-containing nucleation layers having a thickness from about 10 Angstrom to about 1000 μm.

Suitable one or more carbon-containing nucleation layers may include: carbon black, carbon nanotubes, carbon nanofibers, graphite/graphene, hard carbon, glassy carbon, soft carbon, activated carbon (e.g. in fibrous form), or a combination thereof. In some cases, the carbon-containing nucleation layer can comprise amorphous carbon (e.g., a carbon black, such as TIMCAL Super C65). Techniques such as the doctor blade coating method, slot die coating method, ultrasonic spray deposition, screen printing method, physical vapour deposition (PVD) and chemical vapour deposition (CVD) may also be used to prepare such carbon-containing nucleation layers.

Alternatively, the anode current collector also includes two or more nucleation layers formed on one or more surfaces of the anode current collector, prior to an initial first charge cycle of the anode-free sodium cell. In one embodiment, such two or more nucleation layers are preferably two or more carbon-containing nucleation layers.

Alternatively, the anode current collector disclosed herein does not include one or more nucleation layers on one or more surfaces of the anode current collector prior to an initial first charge cycle of the anode-free sodium cell. Therefore, the anode current collector is “pristine” prior to an initial first charge cycle of the anode-free sodium cell. As used herein, the phrase “pristine” means that it is in its “as made” state prior to an initial first charge cycle of the anode-free sodium cell. In other words, the anode current collector is essentially the pure material from which it is formed from, barring impurities (e.g. surface oxide layers etc). As such the anode current collector is not coated with one more nucleation layers (as discussed above), conventional active materials, binders, or the like.

Following charge and discharge cycles, the anode current collector in a fully Na-stripped state may be identical to the “pristine” state, or it may incorporate one or more layers substantially comprising sodium-containing material. It may also comprise inorganic-rich and/or organic-rich materials, from for example, the electrolyte composition, and decomposition products thereof.

Based on the disclosures herein, it is believed that an anode-free sodium cell according to the present invention may be formed using any type of sodium-containing active material serving as the cathode in a sodium-ion cell. Therefore, sodium-containing active materials for use in an anode-free sodium cell may be defined according to the sodium-containing active materials as set out above for use in a sodium-ion cell.

The electrolyte compositions of the present invention are also especially useful in sodium metal cells. Such sodium metal cells may be used in an energy storage device, for example a battery, a rechargeable battery, an electrochemical device and an electrochromic device.

Thus, in a further aspect, the present invention provides a sodium metal cell comprising an electrolyte composition as defined herein. More particularly, in one aspect, the present invention provides:
a sodium metal cell comprising:
a cathode comprising one or more cathode active materials;
an anode current collector comprising sodium metal as an anode active material;
a separator located between the cathode and the anode current collector; and
an electrolyte composition as defined herein.

The present invention also provides in another aspect the use of an electrolyte composition as defined herein in a sodium metal cell.

Ideally, the anode current collector comprises a layer or film of sodium metal with a thickness typically from greater than 0 to about 1000 μm. Such layer or film is typically coated/deposited on the surface of the anode current collector using deposition techniques (e.g. physical vapour deposition) or coating techniques such as mixing sodium metal with a binder material (such as PVDF) and optionally including conductive additives (such as carbon black and/or carbon nanotubes), whilst mixing using a non-aqueous solvent such as N-methyl Pyrrolidone (NMP), and then coating via techniques such as doctor blade or slot die methods.

Preferably, the anode current collector is any substrate that is typically used in an anode-free cell as defined above. Examples include: aluminium foil, copper foil, and carbon paper.

Suitable cathode active materials may be sodium-containing active materials that are defined according to the sodium-containing active materials as set out above for use in a sodium-ion cell. Alternatively, suitable cathode active materials may include sodium-deficient cathode materials such as FeS₂, TiS₂, Na₀₊ₓFePO₄, Na₀₊ₓ, VPO₄F, Na₀₊ₓFe₂(CN)₆, Na₀₊ₓMnFe(CN)₆ (where x can be between 0 and 1), etc.

The present invention also provides in another aspect, a method of operating one or more metal-ion cells as disclosed herein, and/or one or more anode-free sodium cells as disclosed herein. The method comprises the step of cycling the one or more cells at a C-rate of about C/≥2, more preferably at a C-rate of about C/≥5.

In one embodiment, the method comprises the step of discharging the one or more cells at a discharge C-rate of about C/≥2, more preferably at a rate of about C/≥5. For the avoidance of any doubt, the discharge C-rate is the discharge current divided by the theoretical current draw under which the cell would deliver its nominal rated capacity in the specified period of hours. Therefore, a discharge C-rate of C/≥2 means that a discharge current will discharge the entire cell in 2 or more hours. Similarly, a discharge C-rate of C/≥5 means that a discharge current will discharge the entire cell in 5 or more hours. In some cases, the step of discharging the one or more cells at a discharge C-rate of about C/≥7, optionally a C-rate of about C/≥10, optionally a C-rate of about C/≥20, optionally a C-rate of about C/≥50.

In one embodiment, the step of discharging the one or more cells at a discharge C-rate of from C/≥22 to C/≤200, further preferably from C/≥2 to C/≤100, further preferably from C/≥22 to C/≥550, further preferably from C/≥22 to C/≤20, and ideally from C/≥22 to C/≤10. The aim of the method of operating one or more cells according to the present therefore is to utilise the electrolyte compositions according to the present invention at low C rates such as C/≥5, C/≥10, or even C/≥20, in a cell to yield excellent long-term cycling stability and high battery performance. Thus, the electrolyte compositions according to the present invention are particularly useful for stationary applications which require a capacity release over elongated time spans.

The present invention also provides in another aspect an apparatus comprising one or more metal-ion cells as disclosed herein, and/or one or more anode-free sodium cells as disclosed herein, and/or one or more sodium metal cells as disclosed herein. A typical apparatus may include a device such as a battery pack that may have use in either a stationary or a mobile application.

In one embodiment, the apparatus further comprises one or more metal-ion cells having an electrolyte composition that comprises one or more metal-containing salts in a concentration that exceeds the present invention. Ideally, this will be greater than 0.2 mol/kg. Thus, one or more metal-ion cells comprising an electrolyte composition according to the present invention may be mixed with one or more metal-ion cells comprising an electrolyte composition not according to the present invention.

In a further aspect, the present invention also provides a method of accessing available energy from an electrochemical cell comprising:
operating the electrochemical cell with an electrolyte composition comprising a solvent system which comprises:
a first component comprising one or more non-aqueous solvents;
a second component comprising one or more performance additives selected from sulfur-containing compounds, boron-containing compounds, and surfactants; and
wherein the electrolyte composition further comprises one or more metal-containing salts in a concentration from 0 mol/kg to ≤0.2 mol/kg.

The electrolyte composition and/or electrochemical cell may be further defined as set out above or as defined according to the examples disclosed herein.

In one embodiment, the method further includes providing an electrochemical cell and then operating the electrochemical cell with an electrolyte composition according to the present invention. The step of operating the electrochemical cell preferably includes cycling the electrochemical cell at a C-rate of about C/≥2, more preferably at a C-rate of about C/≥5. In one embodiment, the method comprises the step of discharging the electrochemical cell at a discharge C-rate of about C/≥2, more preferably at a rate of about C/≥5.

As set out above, a discharge C-rate of C/≥2 means that a discharge current will discharge the entire cell in 2 or more hours. Similarly, a discharge C-rate of C/≥5 means that a discharge current will discharge the entire cell in 5 or more hours. In some cases, the step of discharging the one or more cells at a discharge C-rate of about C/≥7, optionally a C-rate of about C/≥10, optionally a C-rate of about C/≥20, optionally a C-rate of about C/≥50. In one embodiment, the step of discharging the one or more cells at a discharge C-rate of from C/≥2 to C/≥200, further preferably from C/≥2 to C/≥100, further preferably from C/≥2 to C/≤50, further preferably from C/≥2 to C/≤20, and ideally from C/≥2 to C/≤10.

In one embodiment, the method further includes associating or integrating the available energy from the electrochemical cell with one more additional electrochemical cells having one or more metal-containing salts in a concentration of greater than 0.2 mol/kg.

In a further aspect, the present invention also provides a method of manufacturing an electrochemical cell as defined herein. Preferably, the method comprises:
introducing to the electrochemical cell, an electrolyte composition comprising a solvent system which comprises:
a first component comprising one or more non-aqueous solvents;
a second component comprising one or more performance additives selected from sulfur-containing compounds, boron-containing compounds, and surfactants; and
wherein the electrolyte composition further comprises one or more metal-containing salts in a concentration from 0 mol/kg to ≤0.2 mol/kg.

The electrolyte composition and/or electrochemical cell may be further defined as set out above or as defined according to the examples disclosed herein.

In one embodiment, the method of manufacturing further includes providing an electrochemical cell and then introducing to the electrochemical cell, an electrolyte composition according to the present invention.

In one embodiment, an electrochemical cell is prepared by the method of manufacturing as defined herein.

In further aspect, the present invention also provides an apparatus comprising an electrochemical cell as disclosed herein. The apparatus may further comprise one or more electrochemical cells having an electrolyte composition that comprises one or more metal-containing salts in a concentration that exceeds the present invention. Ideally, this will be greater than 0.2 mol/kg. Thus, an electrochemical cell comprising an electrolyte composition according to the present invention may be mixed with one or more additional electrochemical cells comprising an electrolyte composition not according to the present invention.

In a further aspect, the present invention also provides an electrolyte composition comprising a solvent system which comprises: a first component comprising one or more non-aqueous solvents; a second component comprising one or more performance additives including sulfur-containing compounds; and wherein the electrolyte composition further comprises one or more metal-containing salts in a concentration from 0 mol/kg to ≤0.2 mol/kg. The electrolyte composition may be further defined as set out above or as defined according to the examples disclosed herein.

In a further aspect, the present invention also provides an electrolyte composition comprising a solvent system which comprises: a first component comprising one or more non-aqueous solvents; a second component comprising one or more performance additives in an amount of >0.5 to ≤10% by weight of the solvent system selected from boron-containing compounds, and surfactants; and wherein the electrolyte composition further comprises one or more metal-containing salts in a concentration from 0 mol/kg to ≤0.2 mol/kg. The electrolyte composition may be further defined as set out above or as defined according to the examples disclosed herein.

In a final aspect, the present invention also provides an electrolyte composition having a solvent system which comprises: a first component comprising one or more non-aqueous solvents; a second component comprising one or more performance additives selected from sulfur-containing compounds, boron-containing compounds, and surfactants; and wherein the composition further comprises one or more metal-containing salts in a concentration from 0 mol/kg to ≤0.2 mol/kg. The electrolyte composition may be further defined as set out above or as defined according to the examples disclosed herein.

### BRIEF DESCRIPTION OF THE DRAWINGS

The present invention will now be described with reference to the following figures in which:

FIG. 1 shows a plot of cathode discharge capacity (mAh/g) against cycle number for a cell (APFC489) that uses an electrolyte composition according to the present invention (sample SOL 21).

FIG. 2 shows a plot of full cell voltage (V) against cathode specific capacity (mAh/g) for the first four cycles of cell (APFC489) that uses an electrolyte composition according to the present invention (sample SOL 21).

FIG. 3 shows a plot of full cell voltage (V) against cathode specific capacity (mAh/g) for cycle 5 onwards for cell (APFC489) that uses an electrolyte composition according to the present invention (sample SOL 21).

FIG. 4 shows a plot of full cell voltage (V) against cathode specific capacity (mAh/g) showing the rate performance at various C rates for cycles 3 to 10 of cell (APFC488) that uses an electrolyte composition according to the present invention (sample SOL 21).

FIG. 5 shows a plot of cathode discharge capacity (mAh/g) against cycle number for cell (APFC488) that uses an electrolyte composition according to the present invention (sample SOL 21).

FIG. 6 shows a plot of full cell voltage (V) against cathode specific capacity for (mAh/g) cycle 11 onwards for cell (APFC488) that uses an electrolyte composition according to the present invention (sample SOL 21).

FIG. 7 shows a plot of cathode capacity (mAh/g) against cycle number for cell (APFC475) that uses an electrolyte composition according to the present invention (sample SOL 21).

FIG. 8 shows a plot of cathode discharge capacity (mAh/g) against cycle number to illustrate the cycling stability for a cell (APFC489) that uses an electrolyte composition according to the present invention (sample SOL 21), compared against the cycling stability of a cell (APFC 492) which uses a control electrolyte composition (sample TEL 67a).

FIG. 9 shows a plot of full cell voltage (V) against cathode discharge capacity (mAh/g) at cycle 3 to illustrate a cell (APFC489) that uses an electrolyte composition according to the present invention (sample SOL 21), compared against a cell (APFC 492) which uses a control electrolyte composition (sample TEL 67a).

FIG. 10 shows a plot of full cell voltage (V) against cathode discharge capacity (mAh/g) at cycle 6 to illustrate a cell (APFC489) that uses an electrolyte composition according to the present invention (sample SOL 21), compared against a cell (APFC 492) which uses a control electrolyte composition (sample TEL 67a).

FIG. 11 shows a plot of the full cell voltage (V) against cathode specific capacity for (mAh/g) for the first four cycles of a cell (APFC485) that uses an electrolyte composition according to the present invention (sample SOL 14w).

FIG. 12 shows a plot of cathode discharge capacity (mAh/g) against cycle number for a cell (APFC485) that uses an electrolyte composition according to the present invention (sample SOL 14w).

FIG. 13 shows a plot of the full cell voltage (V) against cathode specific capacity (mAh/g) for the first four cycles of a cell (APFC491) that uses an electrolyte composition according to the present invention (sample SOL 9c).

FIG. 14 shows a plot of cathode discharge capacity (mAh/g) against cycle number for a cell (APFC485) that uses an electrolyte composition according to the present invention (sample SOL 14w), compared against a further cell (APFC491) that uses another electrolyte composition according to the present invention (sample SOL 9c).

FIG. 15 shows a plot of cathode discharge capacity (mAh/g) against cycle number for a cell (APFC489) that uses an electrolyte composition according to the present invention (sample SOL 21), compared against a further cell (APFC490) that uses another electrolyte composition according to the present invention (sample SOL 21a).

FIG. 16 shows a plot of cathode discharge (mAh/g) capacity against cycle number for a cell (APFC487) that uses an electrolyte composition according to the present invention (sample SOL 16 h).

FIG. 17 shows a plot of full cell voltage (V) against cathode specific discharge capacity (mAh/g) for the first two cycles of cell (APFC487) that uses an electrolyte composition according to the present invention (sample SOL 16 h).

FIG. 18 shows a plot of full cell voltage (V) against cathode discharge capacity (mAh/g) for cycles 12, 30 and 61 of cell (APFC487) that uses an electrolyte composition according to the present invention (sample SOL 16 h).

FIG. 19 shows a plot of full cell voltage (V) vs cathode discharge capacity (mAh/g) to illustrate the cycling performance for an anode free sodium cell that uses an electrolyte composition according to the present invention (SOL 21c).

FIG. 20 shows a plot of full cell voltage (V) against cathode discharge capacity (mAh/g) for cell (APFC497) which uses a control electrolyte composition (sample TEP).

FIG. 21 shows a plot of full cell voltage (V) against cathode discharge capacity (mAh/g) for cell (APFC498) which uses a control electrolyte composition (sample TEP).

FIG. 22 shows a plot of full cell voltage (V) against cathode discharge capacity (mAh/g) for cells that use electrolyte compositions according to the present invention (sample SOL 21d; SOL 21e; SOL 21f; SOL 21; and SOL 21 h), compared against a control electrolyte composition (sample TEP).

FIG. 23 shows a plot of full cell voltage (V) against cathode discharge capacity (mAh/g) for cells that use electrolyte compositions according to the present invention (sample SOL 21d; and SOL 21 g), compared against a control electrolyte composition (sample TEP).

FIG. 24 shows a plot of cathode discharge capacity (mAh/g) against cycle number for cells APFC488 and APFC514 that use an electrolyte composition according to the present invention (sample SOL 21).

FIG. 25 shows a plot of full cell voltage (V) against cathode discharge capacity (mAh/g) for a cell (APFC518) that uses an electrolyte composition according to the present invention (sample TEL 84), compared against a further cell (APFC489) that uses an electrolyte composition according to the present invention (sample SOL 21).

FIG. 26 shows a plot of full cell voltage (V) against cathode discharge capacity (mAh/g) for a cell (APFC497) that uses a control electrolyte composition (sample TEP), compared against a further cell (APFC531) that uses a control electrolyte composition (sample TEL 84a).

FIG. 27 shows a plot of full cell voltage (V) against cathode discharge capacity (mAh/g) for a cell (APFC527) that uses an electrolyte composition not according to the present invention (sample TEL 82), compared against a further cell (APFC528) that uses an electrolyte composition according to the present invention (sample SOL 21).

FIG. 28 shows a plot of cathode discharge capacity (mAh/g) against cycle number for a cell (APFC542) that use an electrolyte composition according to the present invention (sample SOL 25a), compared against cells (APFC541; APFC551) with a control electrolyte composition (sample SOL 25; LP 30).

FIG. 29 shows a plot of full cell voltage (V) against cathode discharge capacity (mAh/g) for cells (APFC488; APFC547; APFC548) that use electrolytes composition according to the present invention (sample SOL 21; TEL 80f; TEL 80 g)

### EXAMPLES

The electrolyte compositions under investigation were prepared using the following general procedure: appropriate amounts of a first component (e.g., solvents for the desired solvent system) and then the second component (e.g., the correct amount of one or more performance additives) were weighted out in an argon-filled glove box and added to a brown or clear glass bottle. To dry the formed solvent thoroughly, 4 Å molecular sieves (Sigma-Aldrich) were added and allowed to dry the solvent mixture for at least 24 h. The electrolyte composition was then ready to be used and stored in the argon-filled glovebox. For those compositions containing metal-containing salts (either according to the present invention or otherwise), the required weight of the salt(s) was added to another bottle (either a clear or brown glass bottle or a container made from alternate materials such as polypropylene, PTFE, stainless steel etc), to which the required quantity of the solvent-mixture was added. The electrolyte was then stirred either via a magnetic pellet or a mechanical stirrer for any duration between 5 min-100 h, or alternatively, the salt(s) was allowed to naturally dissolve in the electrolyte by simply letting the bottle/container stand undisturbed or in an accelerated fashion by mechanically shaking the bottle/container.

The precise composition of each of the electrolyte compositions investigated, is detailed in Table 1 below:

TABLE 1

| Electrolyte | |
|---|---|
| Composition | |
| Sample Ref. | Composition |
| TEL 67a (not | 1m NaPF₆ in PC with 20 wt % DEC, 2 wt % PCS, |
| according to | 1 wt % TMSB, 1 wt % P123 |
| the present | |
| invention) | |
| SOL 21 | TEP with 5 wt % PCS, 1 wt % P123, 1 wt % TMSB |
| SOL 14w | PC with 20 wt % DEC, 2 wt % PCS, 1 wt % TMSB, |
| | 1 wt % P123 |
| SOL 9c | EC:DEC:PC at 1:2:1 wt/wt 1 wt % PCS, 1 wt % P123 |
| SOL 21a | TEP with 10 wt % FEC, 1 wt % P123, 1 wt % TMSB |
| SOL 16H | Tetraglyme:diglyme at 1:1 wt ratio with 5 wt % PCS, |
| | 1 wt % TMSB, 1 wt % P123 |
| SOL 21c | TEP with 3 wt % VC, 2 wt % PCS, 1 wt % P123, |
| | 1 wt % TMSB |
| TEP (not | 100 wt % TEP |
| according to | |
| the present | |
| invention) | |
| SOL 21d | TEP with 1 wt % TMSB |
| SOL 21g | TEP with 5 wt % TMSB |
| SOL 21e | TEP with 1 wt % P123 |
| SOL 21f | TEP with 5 wt % PCS |
| SOL 21h | TEP with 5 wt % PCS, 1 wt % P123, 5 wt % TMSB |
| SOL 25 (not | EC:DMC = 1:1 wt/wt |
| according to | |
| the present | |
| invention) | |
| SOL 25a | EC:DMC = 1:1 wt/wt with 5 wt % PCS, 1 wt % P123, |
| | 1 wt % TMSB |
| TEL 80f | 0.1m NaPF6 in TEP with 5 wt % PCS, 1 wt % P123, |
| | 1 wt % TMSB |
| TEL 80g | 0.05m NaPF6 in TEP with 5 wt % PCS, 1 wt % P123, |
| | 1 wt % TMSB |
| TEL 84 | 1m TBAPF6 in TEP with 5 wt % PCS, 1 wt % P123, |
| | 1 wt % TMSB |
| TEL 84a (not | 1m TBAPF6 in TEP |
| according to | |
| the present | |
| invention) | |
| TEL 82 (not | 1m KPF6 in TEP with 5 wt % PCS, 1 wt % P123, |
| according to | 1 wt % TMSB |
| the present | |
| invention) | |
| LP 30 (not | 1M LiPF6 in EC:DMC = 1:1 v/v |
| according to | |
| the present | |
| invention) | |

For the avoidance of doubt, concentrations expressed by “m” (molality) above relate to the total number of moles of the metal-containing salts, per 1 kg or 1000 g of the solvent system. Alternatively, concentrations expressed by “M” (molarity) above relate to the total number of moles of the metal-containing salts, per litre of the solvent system.

### ABBREVIATIONS USED

EC=Ethylene carbonate, DEC=Diethyl carbonate, PC=Propylene carbonate, FEC=Fluoroethylene carbonate, PCS=1,3-propanediolcyclic sulfate, P123=Poloxamer (Pluronic) P123, TEP=Triethyl phosphate, TMSB=Tris(trimethylsilyl) borate, Tetraglyme=Tetraethylene glycol dimethyl ether, Diglyme=diethylene glycol dimethyl ether, VC=vinylene carbonate, DMC=Dimethyl carbonate.

Please note that in the above Table 1, the wt % of the various solvents and/or performance additives are mentioned with respect to the total solvent system weight.

### Cell Construction

### General Procedure to Make a Hard Carbon Na-Ion Cell

Examples 1 to 4 herein refer to the experimental device characteristics of a small-scale Na-ion pouch cell with nominal capacity of approximately 4 to 7 mAh.

Sodium-ion cells were fabricated using a mixed phase O3/P2 oxide cathode, hard carbon anode, and electrolyte (as appropriate). Aluminium tabs were connected to each of the electrodes and the cell was encased in a polymer-coated aluminium pouch.

The positive (cathode) electrode was prepared by solvent-casting a slurry of the active material, conductive carbon, binder and solvent using the doctor blade method. The conductive carbon used was C65 (Imerys). PVdF co-polymer (e.g. W #7500 from Kureha Chemicals) was used as the binder, and N-methyl Pyrrolidone (NMP) was employed as the solvent. The slurry was then cast onto carbon-coated aluminium foil and dried at about 120 °C under vacuum. The electrode film contained the following components, expressed in percent by weight: 89% (or 92%) active material, 5% (or 4%) C65 carbon, and 6% (or 4%) W #7500 binder.

The hard carbon negative (anode) electrode was prepared by solvent-casting a slurry of the hard carbon active material (Kuranode Type 1, supplied by Kureha), conductive carbon, binder and solvent, by the doctor blade method. The conductive carbon used was C65 (Imerys). A mixture of sodium carboxymethylcellulose (CMC) (Aqualon™ AQU D-5283 from Ashland) and styrene-butadiene rubber (SBR) (BM-451 B from Zeon Europe Gmbh) was used as the binder, and water was employed as the solvent. The slurry was then cast onto carbon-coated aluminium foil and dried at about 120 °C under vacuum. The electrode film contained the following components, expressed in percent by weight: 95% active material, 1.5% C65 carbon, and 3.5% binder mixture.

After coating the cathode and anode, they were stamped at the desired dimensions.

The separator used was a typical polyolefinic separator used commonly for any type of rechargeable lithium-ion or sodium-ion battery, such as Celgard 2500. The cathode/separator/anode assembly was placed within a pouch with two Al-based connecting tabs serving as the terminals, inside the glove box, and filled with the stated liquid electrolytes in quantities typical of such types of polyolefinic separator-containing lithium-ion or sodium-ion cells. These pouch cells were then sealed in the glove box and brought out for cell testing.

General Procedure to Make an Anode-free sodium cell

The anode-free sodium-cells described in experiment 5 were fabricated as a pouch cell. The nominal capacity of an anode-free pouch cell was around 5 mAh. The cathode contained a mixed-phase O3/P2 layered oxide sodium-ion active material which was mixed with C65 carbon black conductive additive and polyvinylidene fluoride (PVDF) binder with weight ratio of 89:06:05 on carbon-coated Al foils.

More specifically, the anode was a En' Safe 92' substrate, which was an aluminium foil coated with a thin (about 1 μm) carbon primer layer, and procured from ARMOR (their En' Safe® series of products).

The rest of the procedure for making the anode-free sodium cell was the same as that of the Na-ion pouch cell described as above.

### General Procedure to Make a Hard Carbon K-Ion Cell

The K-ion cells as exemplified herein used P3-type K_{0.5}[Mn_{0.8}Fe_{0.5}Ni_{0.1}]O₂ layer oxide cathode (whose performance was shown previously by Choi et al., Energy Storage Mater., 2020, 25, 714-723). This cathode's formulation was the same as that used for the Na-ion layered O3/P2 oxide and coated on carbon-coated Al foil. The anode used in these cells was hard carbon coated on Al foil (the same as that used for all Na-ion cells experiments). The rest of the procedure for making the K-ion cell was the same as that of the Na-ion pouch cell as described above.

### General Procedure to Make a Graphite Anode-Based Li-Ion Cell

The Li-ion cells as exemplified herein used a layered Li Ni—Mn—Co oxide cathode (NMC532) (purchased from MTI). This cathode's formulation was the same as that used for the Na-ion layered O3/P2 oxide and coated on carbon-coated Al foil. The anode used in these cells was graphite (purchased from MTI) and coated on Cu foil. The rest of the procedure for making the Li-ion cell was the same as that of the Na-ion pouch cell as described above.

### Cell Testing

The cells were tested using Constant Current (Galvanostatic) Cycling techniques.

The cells were cycled at a given current density between pre-set voltage limits. A commercial battery cycler from MTI Inc. (Richmond, CA, USA) or Maccor (Tulsa, OK, USA) was used. On charge, alkali ions are inserted into the carbon-containing anode material (or plated as alkali metal on the substrate, for anode-free cells). During discharge, alkali ions are extracted from the anode (for anode-free cells, the alkali metal is stripped from the substrate as alkali ions) and re-inserted into the cathode active material.

All cells were subject to cycling experiments at a charge rates such as ±C/≥5 and ±C/≥10 (or other rates, such as ±C/≥50, as mentioned for each experiment). Rate performance tests saw discharge rates of C/≥5, C/≥10, 1C and 2 C also. All cells were rested for 4-24 h prior to cycling. Table 2 provides a summary of the conditions of each experiment.

TABLE 2
Summary of Cycling Experiments

| | | | | | | Cathode | | |
|---|---|---|---|---|---|---|---|---|
| Experiment | | Sample | Cell | Anode | Saltless | Electrolyte | | |
| No. | Experiment type | No. | type | Material | electrolyte? | No. | Electrolyte composition | C/A |
| 1A | Initial cycling | APFC489 | Sodium | Hard | Yes | SOL 21 | TEP with 5 wt % PCS, 1 wt % | 2.57 |
| | | | ion | carbon | | | P123, 1 wt % TMSB | |
| 1B | Rate performance | APFC488 | Sodium | Hard | Yes | SOL 21 | TEP, 5 wt % PCS, 1 wt % P123, | 2.60 |
| | | | ion | carbon | | | 1 wt % TMSB | |
| 1C | Long-term cycling | APFC475 | Sodium | Hard | Yes | SOL 21 | TEP, 5 wt % PCS, 1 wt % P123, | 2.50 |
| | | | ion | carbon | | | 1 wt % TMSB | |
| 2 | Comparison | APFC492 | Sodium | Hard | No | TEL 67a | 1m NaPF₆ in PC with 20 wt % | 2.58 |
| | | | ion | carbon | | | DEC, 2 wt % PCS, 1 wt % | |
| | | | | | | | TMSB, 1 wt % P123 | |
| 3A | Cycling with | APFC485 | Sodium | Hard | Yes | SOL 14w | PC with 20 wt % DEC, 1 wt % | 2.59 |
| | carbonate ester | | ion | carbon | | | PCS, 1 wt % TMSB, 1 wt % P123 | |
| 3B | Cycling with | APFC491 | Sodium | Hard | Yes | SOL 9c | EC:DEC:PC at 1:2:1 wt/wt 1 wt % | 2.52 |
| | carbonate ester | | ion | carbon | | | PCS, 1 wt % P123 | |
| 3C | Cycling with | APFC490 | Sodium | Hard | Yes | SOL 21a | TEP with 10 wt % FEC, 1 wt % | 2.47 |
| | carbonate ester | | ion | carbon | | | P123, 1 wt % TMSB | |
| 4A | Cycling with | APFC487 | Sodium | Hard | Yes | SOL 16H | Tetraglyme:diglyme at 1:1 wt.wt | 2.27 |
| | glyme solvent | | ion | carbon | | | ratio with 5 wt % PCS, 1 wt % | |
| | | | | | | | TMSB, 1 wt % P123 | |
| 5A | Initial cycling | INFC 46 | Anode- | En' Safe | Yes | SOL 21c | TEP with 3 wt % VC, 2 wt % PCS, | N/A |
| | | | free | 92 | | | 1 wt % P123, 1 wt % TMSB | |
| 6A | Additive causation | APFC 497 | Sodium- | Hard | Yes | TEP | 100 wt % TEP | 2.72 |
| | (not according to | | ion | carbon | | | | |
| | present invention) | | | | | | | |
| 6B | Additive causation | APFC 498 | Sodium- | Hard | Yes | TEP | 100 wt % TEP | 2.58 |
| | (not according to | | ion | carbon | | | | |
| | present invention) | | | | | | | |
| 6C | Additive causation | APFC 505 | Sodium- | Hard | Yes | SOL 21d | TEP with 1 wt % TMSB | 2.61 |
| | | | ion | carbon | | | | |
| 6D | Additive causation | APFC 506 | Sodium- | Hard | Yes | SOL 21e | TEP with 1 wt % P123 | 2.79 |
| | | | ion | carbon | | | | |
| 6E | Additive causation | APFC 508 | Sodium- | Hard | Yes | SOL 21f | TEP with 5 wt % P123 | 2.85 |
| | | | ion | carbon | | | | |
| 6F | Additive causation | APFC 510 | Sodium- | Hard | Yes | SOL 21h | TEP with 5 wt % PCS, 1 wt % | 2.70 |
| | | | ion | carbon | | | P123, 5 wt % TMSB | |
| 6H | Additive causation | APFC 509 | Sodium- | Hard | Yes | SOL 21g | TEP with 5 wt % TMSB | 2.86 |
| | | | ion | carbon | | | | |
| 7A | Additive causation | APFC 514 | Sodium- | Hard | Yes | SOL 21 | TEP with 5 wt % PCS, 1 wt % | 2.67 |
| | | | ion | carbon | | | P123, 1 wt % TMSB | |
| 8A | Supporting salt | APFC518 | Sodium- | Hard | Yes | TEL 84 | 1m TBAPF₆ in TEP with 5 wt % | 2.49 |
| | | | ion | carbon | | | PCS, 1 wt % P123, 1 wt % TMSB | |
| 8B | Supporting salt | APFC531 | Sodium- | Hard | Yes | TEL 84a | 1m TBAPF₆ in TEP | 2.51 |
| | | | ion | carbon | | | | |
| 9A | Potassium-ion | APFC527 | Potassium- | Hard | No | TEL 82 | 1m KPF₆ in TEP with 5 wt % PCS, | 2.31 |
| | | | ion | carbon | | | 1 wt % P123, 1 wt % TMSB | |
| 9B | Potassium-ion | APFC 528 | Potassium- | Hard | Yes | SOL 21 | TEP with 5 wt % PCS, 1 wt % | 2.34 |
| | | | ion | carbon | | | P123, 1 wt % TMSB | |
| 10A | Lithium-ion (not | APFC 541 | Lithium- | Graphite | Yes | SOL 25 | EC:DMC = 1:1 wt/wt | 2.09 |
| | according to | | ion | | | | | |
| | present invention) | | | | | | | |
| 10B | Lithium-ion | APFC 542 | Lithium- | Graphite | Yes | SOL 25a | EC:DMC = 1:1 wt/wt with 5 wt % | 2.09 |
| | | | ion | | | | PCS, 1 wt % P123, 1 wt % TMSB | |
| 10C | Lithium-ion (not | APFC 551 | Lithium- | Graphite | Yes | LP 30 | 1M LiPF₆ in EC:DMC = 1:1 v/v | 1.91 |
| | according to | | ion | | | | | |
| | present invention) | | | | | | | |
| 11A | Effect of salt | APFC 547 | Sodium- | Hard | Yes | TEL 80f | 0.1m NaPF₆ in TEP with 5 wt % | 2.37 |
| | concentration | | ion | carbon | | | PCS, 1 wt % P123, 1 wt % TMSB | |
| 11B | Effect of salt | APFC 548 | Sodium- | Hard | Yes | TEL 80g | 0.05m NaPF₆ in TEP with 5 wt % | 2.48 |
| | concentration | | ion | carbon | | | PCS, 1 wt % P123, 1 wt % TMSB | |

### Example 1A—the Cycling Performance of Cells which Use an Electrolyte Composition that Contains Triethyl Phosphate Solvent and One or More Performance Additives

Using the general method discussed above to prepare a hard carbon sodium-ion cell, electrolyte composition SOL 21 was employed to prepare a test pouch cell (APFC489). The cycling performance of the test cell was then investigated by cycling as follows: The first 4 cycles of the cell were operated (charged/discharged) between a voltage range of 4.1 to 0 V at ±C/≥10. From the results shown in FIG. 2, the coulombic efficiency increased from 87.5% for cycle 1 to 98.7% for cycle 4.

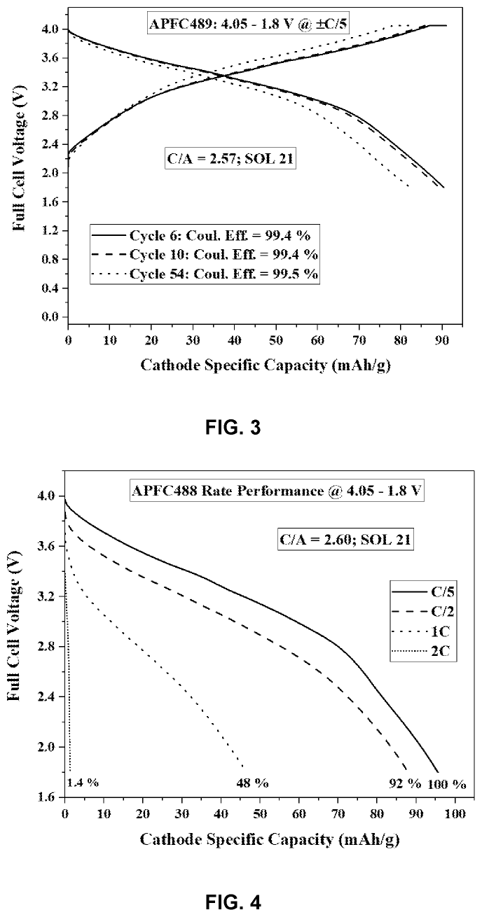

Cycles 5 to cycle 57 of the cell were operated between a voltage range of 4.05 to 1.8 V at ±C/≥5. From the results shown in FIG. 3, the coulombic efficiency remained between 99.4 99.5% from cycles 6 to 54 (see results for cycles 6, 10 and 54).

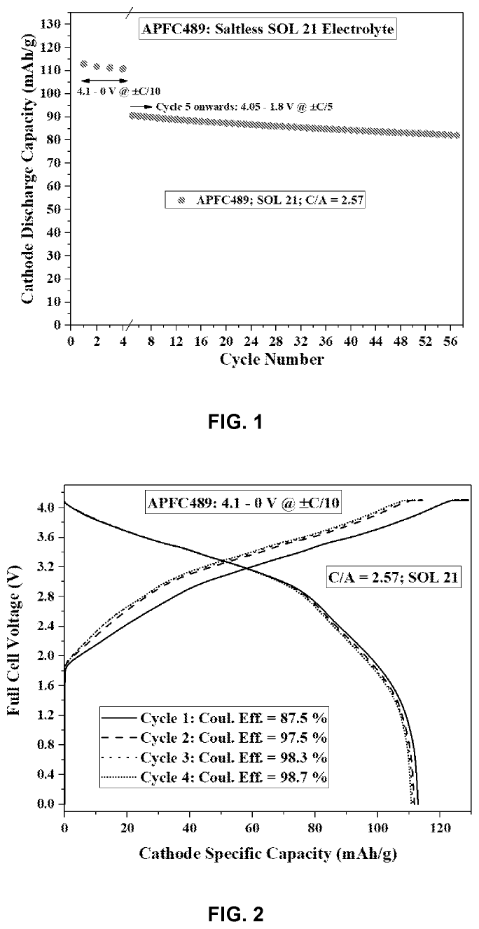

Overall, the cell displayed good cycling stability, retaining 91% cathode discharge capacity in 53 of the ±C/≥5 cycles, shown by FIG. 1.

Thus, good cycling performance in terms of stability and discharge capacity retention is obtained with an electrolyte composition that is substantially free of one or more alkali-metal containing salts (e.g. NaPF₆ as per Example 2 below).

### Example 1B—the Rate Performance of Cells which Use an Electrolyte Composition that Contains Triethyl Phosphate Solvent and One or More Performance Additives

Using the general method discussed above to prepare a hard carbon sodium-ion cell, electrolyte composition SOL 21 was employed to prepare a test pouch cell (APFC488). The rate performance of the test cell was then investigated by cycling as follows: The first two cycles of the cell were operated (charged/discharged) between a voltage range of 4.1 to 0 V at ±C/≥10. Rate performance was assessed on cycles 3 to 10 operated at a voltage range of 4.05 to 1.8 V. During these cycles, the cell was first charged at C/≥5 always.

Subsequently, each pair of cycles, 3-4, 5-6, 7-8, and 9-10 were then discharged at different rates of C/≥5, C/≥2, 1C and 2 C, respectively.

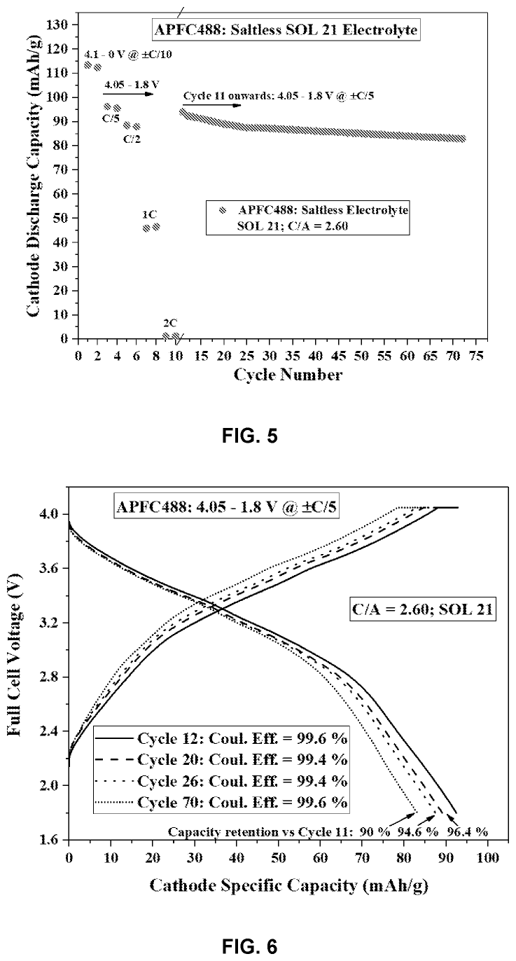

FIG. 5 shows capacity vs cycle number, and up to C/≥2, there is good reversibility. Furthermore, from the rate performance results shown in FIG. 4, the cell discharged up to C/≥2 showed minimal polarisation, and thus the cell discharged at C/≥2 retained 92% cathode specific capacity, and the cell discharged at C/≥5 retained 100% cathode specific capacity. Thus, good rate performance is obtained with an electrolyte composition that is substantially free of one or more alkali-metal containing salts.

As shown more clearly by FIG. 4, the cell discharged at 1 C and 2 C rates retained less than 50% cathode specific capacity (i.e. at 1 C=48% cathode specific capacity; at 2 C=1.4% cathode specific capacity).

The cell was then subject to further cycling at ±C/≥5 between a voltage of 4.05 to 1.8 V from cycle 11 for up to 72 cycles. From the results shown in FIG. 6, the coulombic efficiency remained between 99.4 to 99.6% from cycles 12 to 70 (see results for cycles 12, 20, 26 and 70). Furthermore, the cell maintained a high-capacity retention of over 90% compared to cycle 11, as shown in FIG. 6, exhibiting overall good stability and discharge capacity.

Therefore, it is desirable that a sodium-ion cell is preferably cycled at a rate of about C/≥2, more preferably C/≥5, when using an electrolyte composition that is substantially free of one or more alkali-metal containing salts.

### Example 1C—the Long-Term Cycling Stability of Cells which Use an Electrolyte Composition that Contains Triethyl Phosphate Solvent and One or More Performance Additives

Using the general method discussed above to prepare a hard carbon sodium-ion cell, electrolyte composition SOL 21 was employed to prepare a test pouch cell (APFC475). The long-term cycling stability of the test cell was then investigated over 221 cycles as follows:

The first two cycles of the cell were operated (charged/discharged) between a voltage range of 4.1 to 0 V at ±C/≥5. Cycles 3 to 120 were then operated at a voltage range of 4.05 to 1.8 V at ±1 C (C/≥1). Finally, cycles 121 to 221 were operated at the same voltage range as cycles 3 to 120, but at a rate of ±C/≥5.

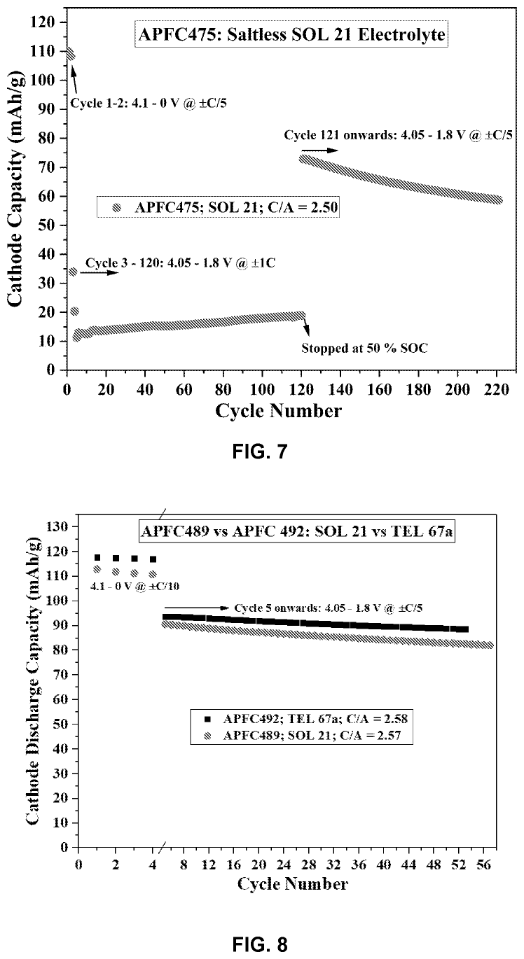

FIG. 7 shows that from cycle 121 to 221 the capacity fade of the cathode is only around 19% (relative to the capacity delivered at cycle 121). Thus, good long-term cycling performance in terms of stability and discharge capacity retention is obtained with an electrolyte composition that is substantially free of one or more alkali-metal containing salts.

Similar to the conclusion of Experiment 1B, it can be seen from FIG. 7 that the delivered capacity at C/≥1 rate was much lower than that at C/≥5 rate (~72.8 mAh/g): at C/≥1 rate, the cell's delivered capacity first decreased from 33.9 mAh/g at cycle 3 to 11.3 mAh/g at cycle 5, but then steadily increased to 18.9 mAh/g at cycle 120, proving that the cell could cycle reversibly at faster cycling rates such as C/≥1, albeit with lower capacities.

Therefore, it is desirable that a sodium-ion cell is preferably cycled at a rate of about C/≥22, more preferably C/≥5, when using an electrolyte composition that is substantially free of one or more alkali-metal containing salts.

### Example 2—Comparison Between Cells According to the Invention, and Cells Using an Electrolyte that Contains Carbonate Ester Electrolyte, One or More Performance Additives, and NaPF₆ Salt (i.e. Not According to the Invention)

Comparative electrolyte composition TEL 67a was prepared in accordance with the disclosure of International Patent Application PCT/GB2020/051317 published as WO2020/240209A1.

Using the general method discussed above to prepare a hard carbon sodium-ion cell, electrolyte composition TEL 67a was employed to prepare a test pouch cell (APFC492). The cycling performance of the test cell was then investigated and the results were compared to test cell APFC489 as discussed in Example 1A above.

APFC492 and APFC489 were both operated (charged/discharged) for 4 cycles between a voltage range of 4.1 to 0 V at ±C/≥10. FIG. 8 shows capacity vs cycle number, and at C/≥10, there is good reversibility of the cathode sodium ions.

From cycles 5 to 57, APFC492 and APFC489 were both operated between a voltage range of 4.05 to 1.8 V at ±C/≥5. FIG. 8 similarly shows at C/≥5 there is good reversibility of the cathode sodium ions.

Surprisingly, at both ±C/≥5 and ±C/≥10 rates, APFC489 (in accordance with the present invention) delivers comparable capacities to APFC492 (not in accordance with the present invention). In fact, the cycling stability of APFC489 is particularly comparable to APFC492 over the first 50+ cycles.

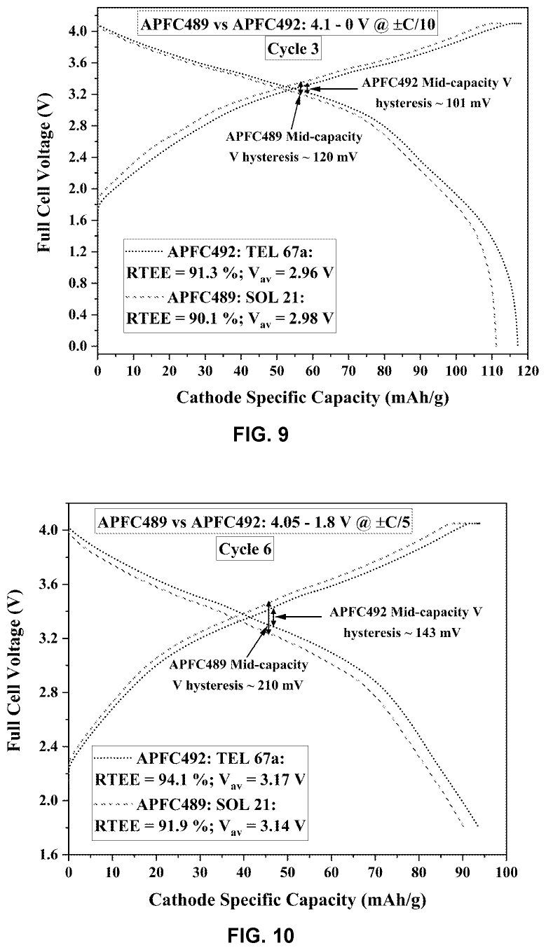

In further detail, FIGS. 9 and 10 show cell voltage vs cathode specific capacity for APFC489 and APFC492 at cycle 3±C/≥5 and cycle 6±C/≥10, respectively. From the results, the extent of polarisation for APFC489 was only slightly higher at both a ±C/≥10 rate and at a ±C/≥5 compared with the respective cycling of APFC492 using TEL 67a. This is reflected in the close mid-capacity voltage hysteresis value for both cells:

At ±C/≥10 as shown by FIG. 9, mid-capacity voltage hysteresis was 120 mV vs 101 mV for APFC489 and APFC492 respectively, resulting in a 19 mV difference.

At ±C/≥5, mid-capacity voltage hysteresis was 210 mV vs 143 mV for APFC489 and APFC492, respectively, resulting in a 67 mV different.

Thus, at ±C/≥10, the hysteresis value is only 19 mV, compared to a value of 67 mV at ±C/≥5.

FIGS. 9 and 10 further show that difference in round-trip-energy-efficiency (RTEE) for both cells were similar (i.e. difference of about 1.2% at ±C/≥10=and about 2.2% at ±C/≥5).

Thus, cycling performance in terms of stability, RTEE and delivered capacity obtained from an electrolyte composition that is substantially free of one or more alkali-metal containing salts, can be essentially similar to that of an electrolyte composition as taught from prior art (containing a significant amount of one or more alkali-metal salts), especially at rates such as C/≥5, or more preferably C/≥10.

### Example 3A—the Cycling and Long-Term Cycling Performance of Cells which Use an Electrolyte Composition that Contains a Carbonate Ester Solvent and One or More Performance Additives

Using the general method discussed above to prepare a hard carbon sodium-ion cell, electrolyte composition SOL 14w was employed to prepare a test pouch cell (APFC485). The cycling performance of the test cell was then investigated by cycling as follows:

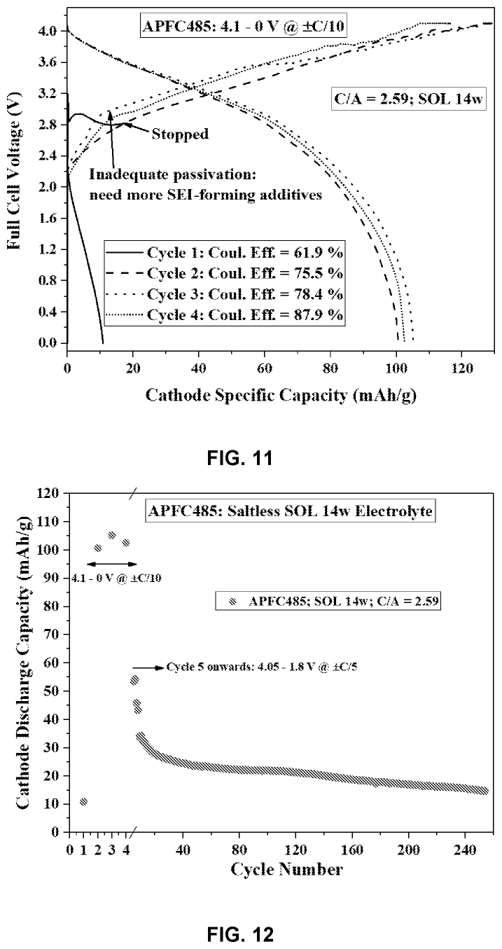

The first four cycles were operated at a voltage range of 4.1 to 0 V at ±C/≥10. The coulombic efficiencies of the first four cycles were from 61.9% at cycle 1, reaching 87.9% by cycle 4, as shown by FIG. 11 (please note that the first charge was prematurely stopped due to human error, as indicated by the arrow).

Cycles 5 to over 250 were operated at a voltage range of 4.05 V to 1.8 V at ±C/≥5. FIG. 12 shows evidence of some reversible cycling at ±C/≥5.

Thus, cycling performance in terms of stability and discharge capacity retention is obtained with an electrolyte composition that is substantially free of one or more alkali-metal containing salts.

The results also indicate that it is particularly desirable that a sodium-ion cell is preferably discharged at a rate of about C/≥210, when using an electrolyte composition comprising a carbonate-containing solvent that is substantially free of one or more alkali-metal containing salts.

### Example 3B—the Cycling and Long-Term Cycling Performance of Cells which Use an Electrolyte Composition that Contains a Carbonate Ester Solvent and One or More Performance Additives

Using the general method discussed above to prepare a hard carbon sodium-ion cell, electrolyte composition SOL 9c was employed to prepare a test pouch cell (APFC491). The cycling performance of the test cell was then investigated by cycling as follows:

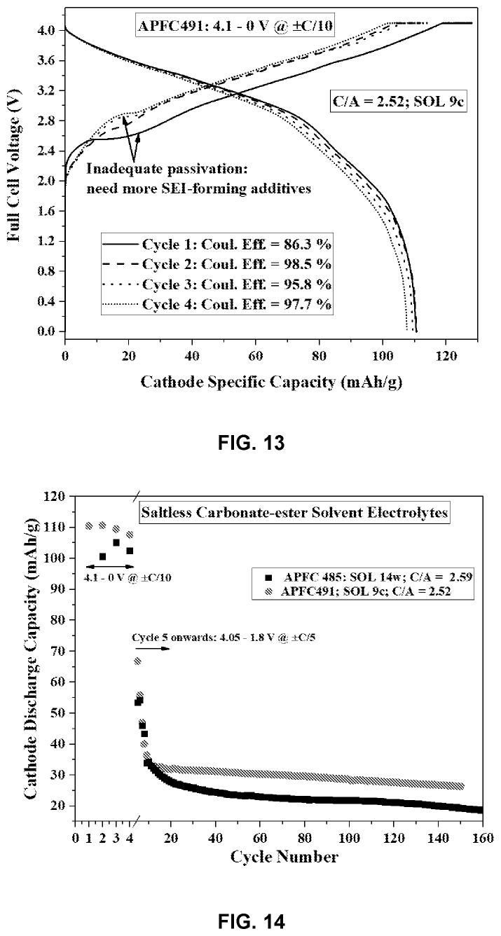

The first four cycles were operated at a voltage range of 4.1 to 0 V at ±C/≥10. The coulombic efficiencies of the first four cycles were from 86.3% at cycle 1, reaching 97.7% by cycle 4, as shown by FIG. 13.

Cycles 5 to over 150 were operated at a voltage range of 4.05 V to 1.8 V at ±C/≥5 and compared to the results obtained for APFC485 of Example 3A, under the same cycling conditions.

From the comparison shown in FIG. 14, higher discharge capacities were observed over the course of 150 cycles, compared to APFC485, indicating a preference to EC:DEC:PC solvent system vs the PC-dominant solvent system of APFC485. For example, at cycle 20 at ±C/≥5, APFC491, using SOL 9c, could deliver 31.9 mAh/g, whilst the cycle 20 capacity of APFC485, using SOL 14w, was lower (27.8 mAh/g).

### Example 3C—the Cycling Performance of Cells which Use an Electrolyte Composition that Contains a Carbonate Ester Solvent in Combination with Triethyl Phosphate Solvent and One or More Performance Additives

Using the general method discussed above to prepare a hard carbon sodium-ion cell, electrolyte composition SOL 21a was employed to prepare a test pouch cell (APFC490). The cycling performance of the test cell was then investigated by cycling as follows:

The first four cycles were operated at a voltage range of 4.1 to 0 V at ±C/≥10. Following this, cycles 5 to over 75 were operated at a voltage of 4.05 to 1.8 V at ±C/≥5 and compared to the results obtained for APFC489 of Example 1A, cycled under the same conditions.

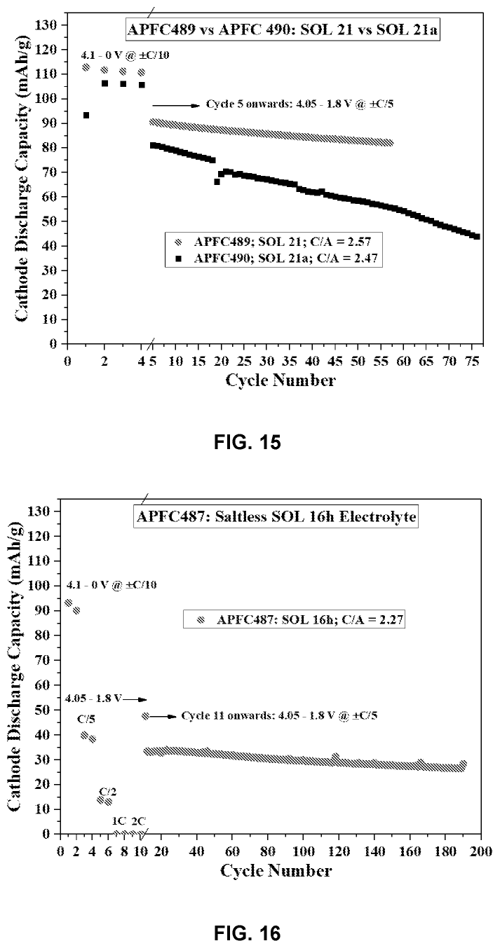

From the results shown in FIG. 15, lower discharge capacities were observed for APFC490 over the course of 75 cycles, compared to APFC489, indicating a preference to TEP-only solvent system vs the TEP with carbonate-ester solvent system of APFC489.

### Example 4A—the Cycling and Rate Performance of Cells which Use an Electrolyte Composition that Contains a Glyme Solvent and One or More Performance Additives

Using the general method discussed above to prepare a hard carbon sodium-ion cell, electrolyte composition SOL 16H was employed to prepare a test pouch cell (APFC487). The rate performance of the test cell was then investigated by cycling as follows: The first two cycles of the cell were operated (charged/discharged) between a voltage range of 4.1 to 0 Vat ±C/≥10.

Rate performance was then assessed on cycles 3 to 10 operated at a voltage range of 4.05 to 1.8 V. During these cycles, the cell was first charged at C/≥5. Subsequently, each pair of cycles, 3-4, 5-6, 7-8, and 9-10 were then discharged at different rates of C/≥5, C/≥2, 1C and 2 C, respectively.

The cell was then subject to further cycling at ±C/≥5 between a voltage of 4.05 to 1.8 V from cycle 11 for up to 190 cycles.

FIG. 16 shows capacity vs cycle number, and at ±C/≥10 there is acceptable discharge capacities of the cathode sodium ions. However, cells discharged at C/≥5, C/≥2, 1C and 2 C rates showed much lower capacities, but nonetheless, demonstrated reversible cycling.

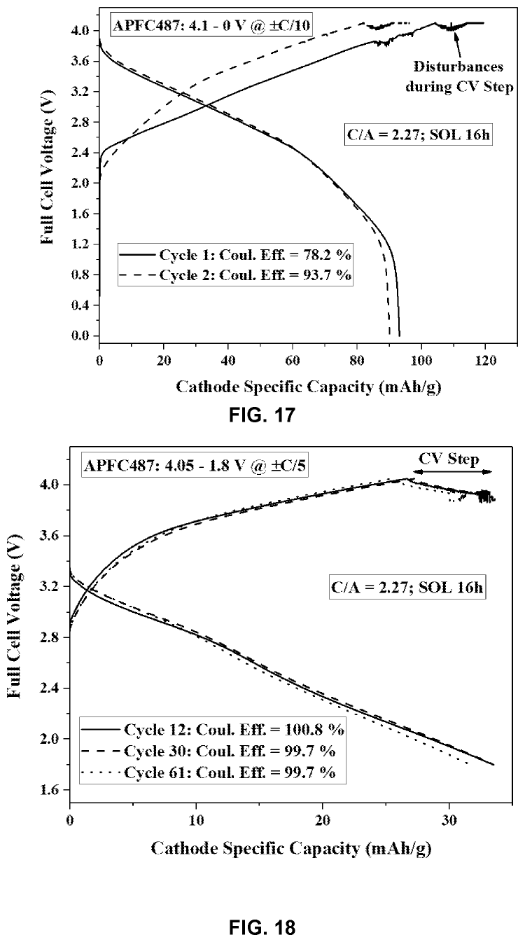

From the results shown in FIG. 17, at ±C/≥10, the coulombic efficiency increased from 78.2% for cycle 1 to 93.7% for cycle 2. However, at the top of charge (from around 3.8 to 4.0 V), in the CV step, there were some disturbances in the cycling profiles.

From the results shown in FIG. 18, at ±C/≥5, the coulombic efficiency decreased from 100.8% for cycle 12 to 99.7% for cycle 12 and 61. Similarly to FIG. 17, at the top of charge in the CV step, there were some disturbances in the cycling profiles.

### Conclusions from Examples 1 to 4

Examples 1-4 embody the surprising result that Na-ion cells can cycle effectively in liquid electrolytes without any salt. The data collected shows that Na-ion cells with saltless electrolytes can show good cycling performance at rates of C/≥2 and slower: such rates are ideally suited for stationary energy storage applications, where a battery is expected to discharge over several hours, such as C/≥5 or even C/≥20.

Evidently, the electrolyte composition is vital in maintaining good cycling stability which is comparable to established high-functioning salt-based cells. The results show that TEP is the championing solvent. However, carbonate ester containing solvents, and glyme containing solvents do also still show different degrees of performance (good capacities, efficiencies, cycling stabilities and rate performance), which in itself is also a highly unexpected result. These experiments also point to the vital nature of additives, especially SEI-forming additives, with Experiment 6 below providing further details on their importance.

### Example 5—The Cycling and Rate Performance of Anode-Free Sodium Cells which Use an Electrolyte Composition According to the Present Invention

Using the general method discussed above to prepare an anode-free sodium cell, electrolyte composition SOL 21c was employed to prepare a test cell (INFC 46). The rate performance of the test cell was then investigated by cycling at ±C/≥10 between a voltage of 4.0 to 1.0 V.

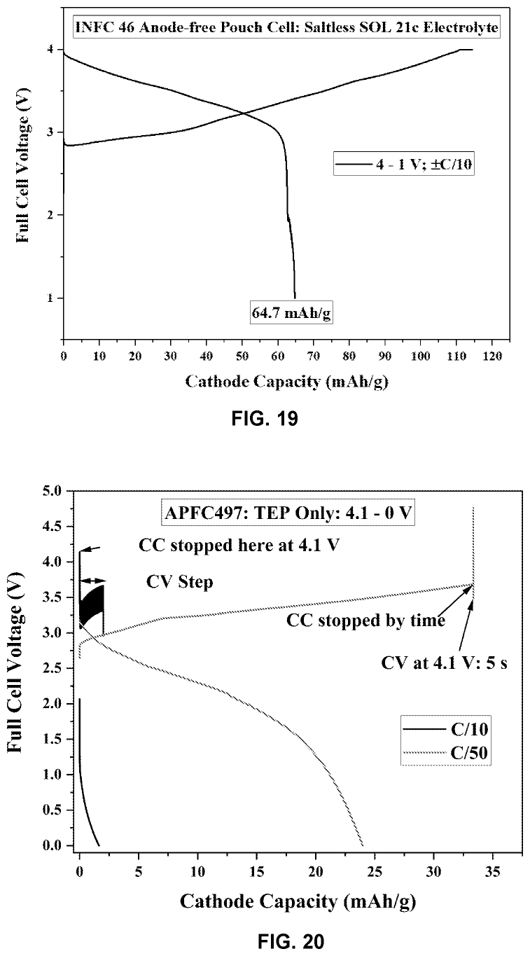

From the results shown in FIG. 19, cell INFC 46 was shown to cycle reversibility using electrolyte composition SOL 21c. Specifically, INFC 46 could deliver a specific capacity of 64.7 mAh/g in the first cycle, thus proving reversibility.

Thus, the results for example 5 led to the conclusion that the compositions according to the present invention have utility in anode-free sodium cells, as well as sodium-ion cells.

### Example 6

This experiment further investigates the cycling performance of hard carbon sodium-ion cells using electrolyte compositions according to the present invention. The purpose of this experiment was to investigate the importance of specific types and amount of additives in saltless electrolytes, to the performance of sodium-ion cells.

### No Additives

Cells APFC497 and APFC 498 were cycled with 100 wt % TEP and cycled at ±C/≥10 between a voltage of 4.1 to 0 V. Both cells were also cycled at ±C/≥50 between a voltage of 4.1 to 0 V.

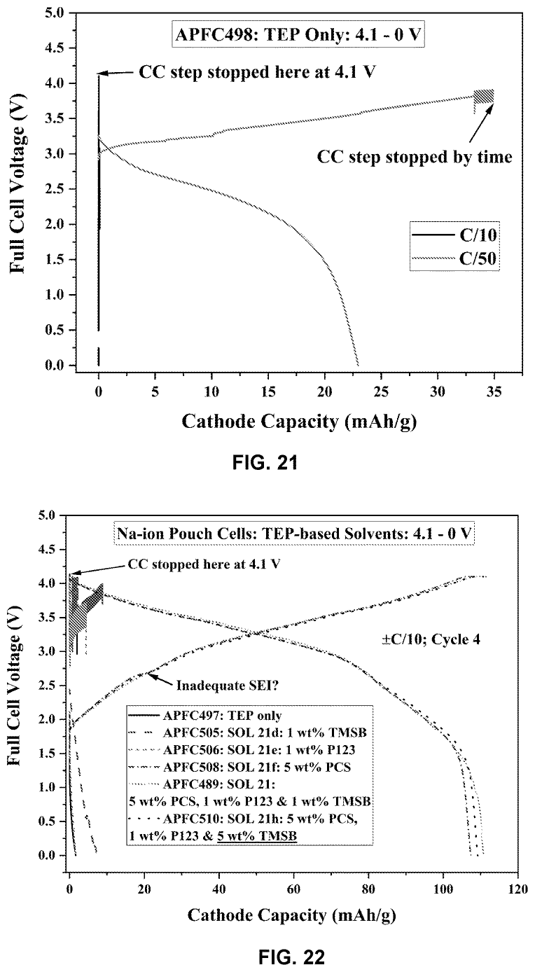

As shown from FIGS. 20 and 21, both APFC497 and APFC 498 instantly polarised and showed negligible capacity when cycled at ±C/≥10. However, when cycled at ±C/≥50, the delivered capacity was unexpectedly higher; for example, the ±C/≥50 capacity of APFC497 was 24 mAh/g despite the cell only being charged to 3.68 V (the cell's charging step was cut-off by time, whereupon the battery cycler automatically went to the CV step at 4.1 V for 5 s, before this was cut-off naturally as well), and the ±C/≥50 capacity of APFC498 was 23 mAh/g (this cell's charging was cut-off by time at 3.90 V, without a subsequent CV step).

The experiment demonstrates that reversible cycling in a sodium ion cell can be achieved using an electrolyte composition that is substantially free of one or more metal containing salts.

### Boron-Containing Additives

Cell APFC505 was cycled with TEP with 1 wt % TMSB (sample SOL 21d) at ±C/≥10 between a voltage of 4.1 to 0 V.

Cell APFC509 was cycled with TEP with 5 wt % TMSB (sample SOL 21 g) at ±C/≥10 between a voltage of 4.1 to 0 V.

As shown from FIG. 22, cell APFC505 led to a charge capacity of 8.8 mAh/g and a discharge capacity of 7.5 mAh/g in the 4^{th} cycle. It can be seen that these delivered capacities at ±C/≥10 are much higher than those seen by Na-ion pouch cells containing just TEP solvent described on the previous page (the cycling profile of APFC497 is also shown on FIG. 22).

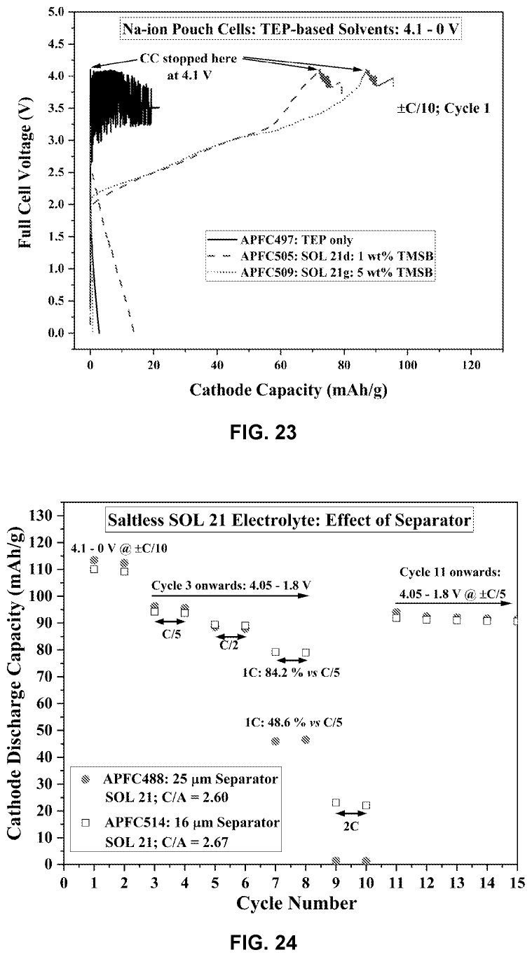

FIG. 23 shows the first cycling profile, at ±C/≥10, of Na-ion cells using saltless electrolytes either without any additives (APFC497 using TEP) or using B-containing additives (AFPC505 using SOL21d or APFC509 using SOL21 g). It can be seen that the presence of TMSB additive, irrespective of amount, had a significant influence on the charging cycle: APFC497 instantly polarised to 4.1 V during the CC step (the charging CC step's capacity was only 0.04 mAh/g), whilst the two TMSB-containing cells delivered significantly higher capacity during the CC step (APFC505 delivered 72.1 mAh/g and APFC509 delivered 86.9 mAh/g during the CC charging step). The influence on the discharge capacity was significant as well, though not as much as the influence during the charging step: the cycle 1 discharge capacity of APFC497 was 2.8 mAh/g, that of APFC505 was 13.7 mAh/g and that of APFC509 was 0.9 mAh/g.

This experiment demonstrates the unexpected performance of the use of boron-containing additives (TMSB) in an electrolyte composition that is substantially free of one or more metal containing salts. In particular, when TMSB is used as a single-additive, it can lead to noticeably higher discharge capacities in Na-ion cells at rates such as C/≥10, as compared to an electrolyte composition that is substantially free of one or more metal containing salts without any additives (i.e. 100% TEP).

### Surfactant Additives

Cell APFC506 was cycled with TEP with 1 wt % P123 (sample SOL 21e) at ±C/≥10 between a voltage of 4.1 to 0 V.

As shown in FIG. 22, it can be seen that APFC506 performed similarly as the baseline APFC497 cell when cycled at ±C/≥10: the fourth cycle discharge capacity of the former was 1.62 mAh/g, while that of the latter was 1.64 mAh/g. Thus, this experiment demonstrates the unexpected performance of the use of surfactants (P123) in an electrolyte composition that is substantially free of one or more metal containing salts.

### S-Containing Additives

Cell APFC508 was cycled with TEP with 5 wt % PCS (sample SOL 21f) at ±C/≥10 between a voltage of 4.1 to 0 V.

As shown from FIG. 22, cell APFC508 led to significantly higher capacities than those obtained from other cells containing other types of single-additives: a charge capacity of 108.7 mAh/g and a discharge capacity of 107.3 mAh/g in the 4^{th} cycle. This experiment demonstrates the unexpected performance of the use of sulfur-containing additives (PCS) in an electrolyte composition that is substantially free of one or more metal containing salts.

### Combinations of Additives

Cell APFC510 was cycled with TEP with 5 wt % PCS, 1 wt % P123, 5 wt % TMSB (sample SOL 21 h) at ±C/≥10 between a voltage of 4.1 to 0 V.

As shown from FIG. 22, cell APFC510 led to a charge capacity of 110.7 mAh/g and a discharge capacity of 109.2 mAh/g in the 4^{th} cycle.

Similarly, cell APFC489 in experiment 1A was cycled with TEP with 5 wt % PCS, 1 wt % P123, 1 wt % TMSB (sample SOL 21) at ±C/≥10 between a voltage of 4.1 to 0 V.

As shown from FIG. 22, cell APFC489 led to a charge capacity of 112.3 mAh/g and a discharge capacity of 110.8 mAh/g in the 4^{th} cycle.

It can be seen that both cells significantly outperformed the baseline cell without any additives (APFC497). This experiment demonstrates the unexpected performance of the use of combinations of additives in an electrolyte composition that is substantially free of one or more metal containing salts.

### Conclusions

It can be seen above that different types of additives have different effects on influencing performance of Na-ion cells using electrolytes that are substantially free of one or more metal containing salts.

Further still, cells APFC489 and APFC510 each showed a greater or similar performance capacity compared to cells APFC505, APFC506 and even APFC508 that used a B-containing, surfactant-containing and S-containing additive alone, respectively. This synergistic performance from a combination of additives to deliver desirable cell characteristics is highly unexpected in an electrolyte composition that is substantially free of one or more metal containing salts.

The results of each of these additives (S-containing, B-containing and surfactant-containing) are indeed surprising as the absence of a salt, causing instant polarisation, would have been expected to trump all subsequent effects of any such additives.

### Example 7

This experiment investigates the cycling performance of hard carbon sodium-ion cells using electrolyte compositions according to the present invention with different polyolefin separators.

Using cells cycled with TEP with 5 wt % PCS, 1 wt % P123, 1 wt % TMSB (sample SOL 21), two different polyolefin separators were investigated:
Cell APFC488 (as per experiment 1B) used a polyolefinic separator having a thickness of 25 μm; and
Cell APFC514 used a polyolefinic separator having a thickness of 16 μm.

The first two cycles of APFC488 and APFC514 were operated (charged/discharged) between a voltage range of 4.1 to 0 V at ±C/≥10. Rate performance was assessed on cycles 3 to 10 operated at a voltage range of 4.05 to 1.8 V. During these cycles, the cell was charged at C/≥5 rate throughout. Subsequently, each pair of cycles, 3-4, 5-6, 7-8, and 9-10 were then discharged at different rates of C/≥5, C/≥2, 1C and 2 C, respectively. After these cycles, the cell was placed for ±C/≥5 cycling at 4.05-1.8 V from cycle 11 onwards.

FIG. 24 shows capacity vs cycle number, and up to C/≥2, there is good reversibility of the cathode sodium ions for both APFC488 and APFC514. It can be seen that the discharge capacity at 1 C rate of APFC514 using the 16 μm separator was significantly higher than that of APFC488 using the 25 μm separator: the former cell delivered ~79 mAh/g, whilst the latter could deliver only ~46 mAh/g. Likewise, the discharge capacity at 2 C rate of APFC514 using the 16 μm separator was significantly higher than that of APFC488 using the 25 μm separator: the former cell delivered ~23 mAh/g, whilst the latter could deliver only ~1.3 mAh/g.

Thus, it can be seen that APFC488 discharged at 1 C and 2 C rates retained less than 50% cathode specific capacity (i.e. at 1 C=48% cathode specific capacity; at 2 C=1.4% cathode specific capacity).

In contrast, APFC514 discharged at 1 C retained greater than 50% cathode specific capacity (i.e. at 1 C=84.2% cathode specific capacity). Furthermore, APFC514 discharged at 2 C retained ~25% of the cathode specific capacity relative to the C/≥5 capacity.

Thus, by decreasing the thickness of the polyolefin separator from 25 μm to 16 μm, it is possible to increase the rate performance of a sodium-ion cell using an electrolyte composition that is substantially free of one or more alkali-metal containing salts.

### Example 8

The present experiment aims to investigate what effect a “supporting salt” may have on the electrochemical performance of a sodium-ion cell using an electrolyte composition according to the present invention. For the purposes of this disclosure, a “supporting salt” is any salt that is not a metal containing salt yet facilitates the transfer of the metal cation (i.e. Na⁺) from the cathode to the anode and vice versa. The supporting salt however, does not take part in the electrochemical process of the electrochemical cell.

The cycling performance was investigated between a voltage of 4.1 to 0 V at ±C/≥10 for two sodium-ion cell as discussed below. Tetrabutylammonium hexafluorophosphate or TBAPF₆ was used as the supporting salt.

### TEL 84

Cell APFC518 was cycled with 1 m TBAPF₆ in TEP with 5 wt % PCS, 1 wt % P123, 1 wt % TMSB (sample TEL 84) at ±C/≥10 between a voltage of 4.1 to 0 V.

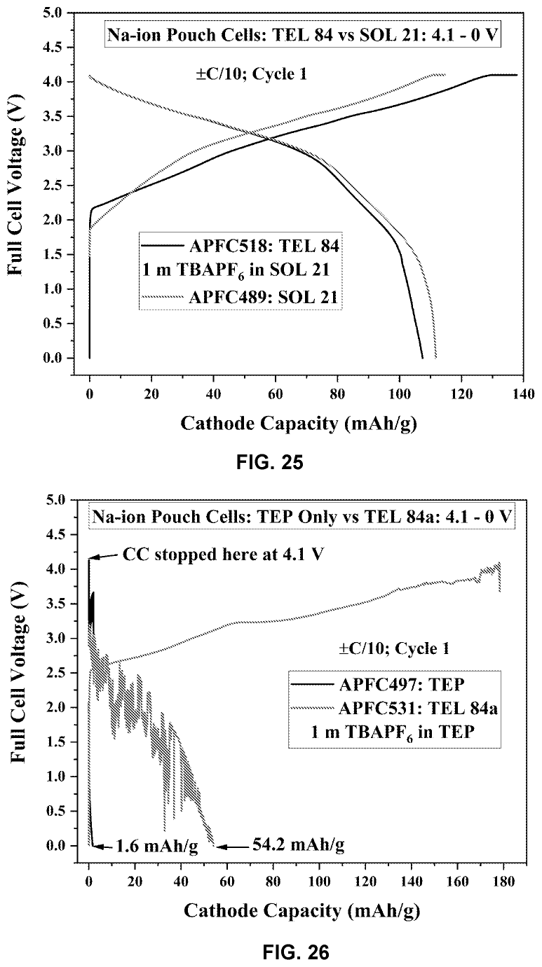

FIG. 25 compares the results of cell APFC518 with cell APFC489 which was cycled with SOL 21 as per experiment 1A.

As shown, the addition of 1 m TBAPFs to SOL21 to form TEL 84 did not significantly impact the electrochemical performance the cell. For instance, at cycle 1, the discharge capacity obtained for APFC489 was 112.9 mAh/g, compared to the discharge capacity at cycle 1 for APFC518 of 107.5 mAh/g.

### TEL 84a

Cell APFC513 was cycled with 1 m TBAPF₆ in TEP (sample TEL 84a) at ±C/≥10 between a voltage of 4.1 to 0 V.

FIG. 26 compares the results of cell APFC513 with cell APFC497 which was cycled with 100 wt % TEP as per experiment 6A.

As shown, the addition of 1 m TBAPF₆ to TEP to form TEL 84a surprisingly increased the electrochemical performance the cell. For instance, at cycle 1, the discharge capacity obtained for APFC487 was 1.6 mAh/g, compared to the discharge capacity at cycle 1 for APFC518 of 54.2 mAh/g.

### Conclusions

Cells cycled with a supporting salt included in an electrolyte composition according to the present invention, showed a greater or similar performance in discharge capacity compared to cells without such a supporting salt.

### Example 9

This experiment investigates the cycling performance of hard carbon potassium ion cells using electrolyte compositions according to the present invention.

Using the general method discussed above to prepare a potassium-ion, cell APFC527 was cycled with TEP with 5 wt % PCS, 1 wt % P123, 1 wt % TMSB (sample SOL 21) at ±C/≥5 between a voltage of 4.1 to 0 V.

The general method discussed above was similarly used to prepare cell APFC528, which was cycled with 1 m KPF₆ in TEP with 5 wt % PCS, 1 wt % P123, 1 wt % TMSB (sample TEL 82) at ±C/≥4 between a voltage of 4.1 to 0 V.

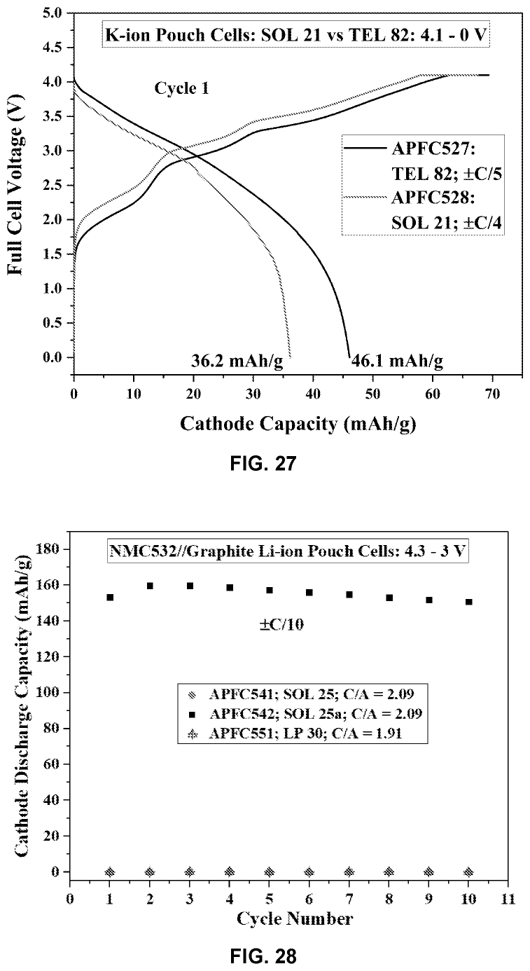

FIG. 27 compares the cycling results of cell APFC527 compared against cell APFC528. As shown, the discharge capacity obtained for APFC527 at cycle 1 was 36.2 mAh/g, compared to the discharge capacity at cycle 1 for APFC528 of 46.1 mAh/g.

### Conclusions

The results of example 9 conclude that the electrolyte compositions according to the present invention have utility in potassium-ion cells, as well as sodium-ion cells, and anode-free sodium cells.

### Example 10

This experiment investigates the cycling performance of graphite anode-based lithium-ion cells using electrolyte compositions according to the present invention.

Using the general method discussed above to prepare a lithium-ion, the following cells were fabricated: APFC541 with saltless electrolyte SOL 25 (EC:DMC=1:1 wt/wt); APFC542 with saltless electrolyte SOL 25a (EC:DMC=1:1 wt/wt with 5 wt % PCS, 1 wt % P123, 1 wt % TMSB; APFC551 with Li metal salt-containing LP 30 electrolyte (1 M LiPF6 in EC:DMC=1:1 v/v). These three cells were cycled at ±C/≥10 between a voltage of 4.3 to 3 V for 10 cycles.

FIG. 28 compares the cycling results of the three cells. It can be seen that the APFC542 cell using saltless electrolyte according to the present invention (SOL 25a) significantly outperformed the other cells. For example, the first and tenth discharge capacities of APFC542 were 153.2 mAh/g and 150.8 mAh/g respectively, whilst the values for APFC541 using the additive-less saltless electrolyte were 0 mAh/g and 0 mAh/g respectively, and the values for APFC551 using metal-containing electrolyte were 0 mAh/g and 0 mAh/g respectively.

### Conclusions

The results of example 10 demonstrates that the electrolyte compositions according to the present invention have utility in lithium-ion cells, as well as sodium-ion cells, potassium-ion cells and anode-free sodium cells. The additives in SOL25a have never been tested in a cell without a salt, thus it is surprising and unexpected that there is in fact a benefit of using SOL25a versus SOL25 and LP 30.

### Example 11

The present experiment aims to investigate what effect a minimal amount of metal-containing salt may have on the electrochemical performance of a sodium-ion cell using an electrolyte composition according to the present invention.

The cycling performance was investigated between a voltage of 4.1 to 0 V at ±C/≥10 for two sodium-ion cells as discussed below, using different concentrations of a very small amount of NaPF₆ salt in TEP with 5 wt % PCS, 1 wt % P123 and 1 wt % TMSB solvent system:

Cell APFC547 was cycled with 0.1 m NaPF₆ in TEP with 5 wt % PCS, 1 wt % P123, 1 wt % TMSB (sample TEL 80f) at ±C/≥10 between a voltage of 4.1 to 0 V.

Cell APFC548 was cycled with 0.05 m NaPF₆ in TEP with 5 wt % PCS, 1 wt % P123, 1 wt % TMSB (sample TEL 80 g) at ±C/≥10 between a voltage of 4.1 to 0 V.

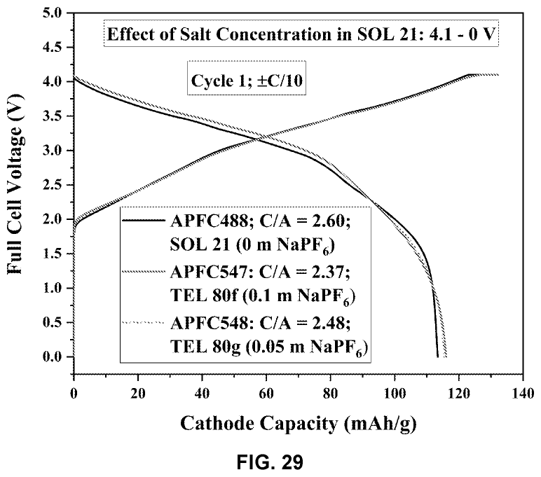

FIG. 29 compares the results of cell APFC547 and APFC548 with cell APFC488 which was cycled with SOL 21 as per experiment 1B. As shown, the addition of 0.1 m or 0.05 m NaPF₆ to SOL21 to form TEL 80f and TEL 80 g, respectively, did not significantly impact the electrochemical performance the cell. For instance, at cycle 1, the discharge capacity obtained for APFC547 was 116.1 mAh/g and that of APFC548 was 115.5 mAh/g, compared to the discharge capacity at cycle 1 for APFC488 of 113.4 mAh/g.

### Conclusions

Cells cycled with an insignificant amount of metal-containing salt included in the electrolyte composition according to the present invention, showed a greater or similar performance in discharge capacity compared to cells without any metal-containing salt. This is a particularly surprising and unexpected result, since cells with such low concentrations of salt would not have been expected to produce such desirable results with just the inclusion of additives.

### Example 12

This experiment investigates the effect on the density of a liquid electrolyte made according to the present invention vs the density of a liquid electrolyte containing a substantial amount of metal salt.

For this purpose, the following two electrolytes were studied:
SOL 14w (according to the present invention): PC with 20 wt % DEC, 2 wt % PCS, 1 wt % TMSB and 1 wt % P123.
TEL 67a (not according to the present invention): 1 m NaPF6 in in PC with 20 wt % DEC, 2 wt % PCS, 1 wt % TMSB, 1 wt % P123

To measure the density of the electrolytes, 25 mL of each electrolyte was weighed. For each electrolyte, three measurements were obtained. The summary of the results obtained, along with standard deviations, are shown below in Table 3:

TABLE 3

| | Density | Density | Density | | |
|---|---|---|---|---|---|
| | of 1^{st} | of 2^{nd} | of 3^{rd} | | |
| Electrolyte | measure- | measure- | measure- | Average | Standard |
| Composition | ment | ment | ment | Density | Deviation |
| Sample Ref. | (g/cm³) | (g/cm³) | (g/cm³) | (g/cm³) | (%) |
| SOL 14w | 1.141 | 1.154 | 1.156 | 1.151 | 0.76 |
| (according to | | | | | |
| the present | | | | | |
| invention) | | | | | |
| TEL 67a (not | 1.268 | 1.27 | 1.265 | 1.268 | 0.21 |
| according to | | | | | |
| the present | | | | | |
| invention | | | | | |

It can be seen from the Table 3 that TEL 67a (not according to the present invention) was around 10% heavier than SOL 14w (according to the present invention). This experiment proves that electrolytes according to the present invention will lead to lighter batteries over those electrolytes which contain a substantial amount of salt, thus boosting the resultant battery's specific energy (Wh/kg) which is very commercially advantageous property.

The subject matter encompassed by the following numbered embodiments also forms part of the present invention, optionally in combination with the subject matter described above and/or defined in the claims that follow.

### Numbered Embodiment 1

Use, as an electrolyte, of a composition comprising a solvent system which comprises:
a first component comprising one or more non-aqueous solvents;
a second component comprising one or more performance additives selected from sulfur-containing compounds, boron-containing compounds, and surfactants; and
wherein the composition further comprises one or more metal-containing salts in a concentration from 0 mol/kg to ≤0.2 mol/kg.

### Numbered Embodiment 2

The use according to numbered embodiment 1, in which the composition is substantially free of one or more metal-containing salts.

### Numbered Embodiment 3

The use according to numbered embodiment 1 or numbered embodiment 2, in which the one or more non-aqueous solvents are selected from organo phosphate-based solvents, organo carbonate-based solvents, and glyme-based solvents.

### Numbered Embodiment 4

The use according to any one of numbered embodiments 1 to 3, in which the second component comprises one or more performance additives in an amount of >0.5 to <10% by weight of the solvent system.

### Numbered Embodiment 5

The use according to any one of numbered embodiments 1 to 4, in which the surfactants are selected from anionic surfactants, cationic surfactants, non-ionic (hydrophilic) surfactants and amphoteric (zwitterionic) surfactants.

### Numbered Embodiment 6

The use according to numbered embodiment 5, in which the surfactants include at least one non-ionic block copolymer surfactant, preferably selected from one or more poloxamers.

### Numbered Embodiment 7

The use according to any one of numbered embodiments 1 to 6, in which the sulfur-containing compounds are selected from sulfone-containing compounds, sulfate-containing compounds, and sulfonate-containing compounds.

### Numbered Embodiment 8

The use according to numbered embodiment 7, in which the sulfur-containing compounds include 1,3-propanediolcyclic sulfate (PCS).

### Numbered Embodiment 9

The use according to any one of numbered embodiments 1 to 8, in which the boron-containing compounds are selected from borate-containing compounds and boroxine-containing compounds.

### Numbered Embodiment 10

The use according to numbered embodiment 9, in which the boron-containing compounds include tris(trimethylsilyl) borate (TMSB).

### Numbered Embodiment 11

The use according to any one of numbered embodiments 1 to 10, in which the first component comprises triethyl phosphate in an amount of about 90% by weight or more of the first component of the solvent system.

### Numbered Embodiment 12

The use according to any one of numbered embodiments 1 to 11, in an electrochemical cell, preferably in a sodium-based electrochemical cell.

### Numbered Embodiment 13

The use according to numbered embodiment 12, in which the electrochemical cell is a metal-ion cell comprising a negative electrode, and a positive electrode.

### Numbered Embodiment 14

The use according to numbered embodiment 13, in which the metal-ion cell is selected from a sodium-ion cell, lithium-ion cell, and a potassium-ion cell.

### Numbered Embodiment 15

The use according to numbered embodiment 12, in which the electrochemical cell is an anode-free sodium cell.

### Numbered Embodiment 16

The use according to any one of numbered embodiments 1 to 15, in an electrochemical cell associated or integrated with one more additional electrochemical cells having one or more metal-containing salts in a concentration of greater than 0.2 mol/kg.

### Numbered Embodiment 17

A method of accessing available energy from an electrochemical cell comprising:
operating the electrochemical cell with an electrolyte composition comprising a solvent system which comprises:
a first component comprising one or more non-aqueous solvents;
a second component comprising one or more performance additives selected from sulfur-containing compounds, boron-containing compounds, and surfactants; and
wherein the electrolyte composition further comprises one or more metal-containing salts in a concentration from 0 mol/kg to ≤0.2 mol/kg.

### Numbered Embodiment 18

The method according to numbered embodiment 17, further comprising associating or integrating the available energy from the electrochemical cell with one more additional electrochemical cells having one or more metal-containing salts in a concentration of greater than 0.2 mol/kg.

### Numbered Embodiment 19

A method of manufacturing an electrochemical cell comprising:
introducing to the electrochemical cell, an electrolyte composition comprising a solvent system which comprises:
a first component comprising one or more non-aqueous solvents;
a second component comprising one or more performance additives selected from sulfur-containing compounds, boron-containing compounds, and surfactants; and
wherein the electrolyte composition further comprises one or more metal-containing salts in a concentration from 0 mol/kg to ≤0.2 mol/kg.

### Numbered Embodiment 20

The method according to any one of numbered embodiments 17 to 19 in which the electrolyte composition is substantially free of one or more metal-containing salts.

### Numbered Embodiment 21

The method according to any one of numbered embodiments 17 to 20, in which the one or more non-aqueous solvents are selected from organo phosphate-based solvents, organo carbonate-based solvents, and glyme-based solvents.

### Numbered Embodiment 22

The method according to any one of numbered embodiments 17 to 21, in which the second component comprises one or more performance additives in an amount of >0.5 to <10% by weight of the solvent system.

### Numbered Embodiment 23

The method according to any one of numbered embodiments 17 to 22, in which the surfactants are selected from anionic surfactants, cationic surfactants, non-ionic (hydrophilic) surfactants and amphoteric (zwitterionic) surfactants.

### Numbered Embodiment 24

The method according to any one of numbered embodiments 17 to 23, in which the surfactants include at least one non-ionic block copolymer surfactant, preferably selected from one or more poloxamers.

### Numbered Embodiment 25

The method according to any one of numbered embodiments 17 to 24 in which the sulfur-containing compounds are selected from sulfone-containing compounds, sulfate-containing compounds, and sulfonate-containing compounds.

### Numbered Embodiment 26

The method according to numbered embodiment 25, in which the sulfur-containing compounds include 1,3-propanediolcyclic sulfate (PCS).

### Numbered Embodiment 27

The method according to any one of numbered embodiments 17 to 26, in which the boron-containing compounds are selected from borate-containing compounds and boroxine-containing compounds.

### Numbered Embodiment 28

The method according to numbered embodiment 27, in which the boron-containing compounds include tris(trimethylsilyl) borate (TMSB).

### Numbered Embodiment 29

The method according to any one of numbered embodiments 17 to 28, in which the first component comprises triethyl phosphate in an amount of about 90% by weight or more of the first component of the solvent system.

### Numbered Embodiment 30

The method according to any one of numbered embodiments 17 to 29, in which the electrochemical cell is a sodium-based electrochemical cell.

### Numbered Embodiment 31

The method according to any one of numbered embodiments 17 to 29, in which the electrochemical cell is a metal-ion cell comprising a negative electrode, and a positive electrode.

### Numbered Embodiment 32

The method according to numbered embodiment 31, in which the metal-ion cell is selected from a sodium-ion cell, lithium-ion cell, and a potassium-ion cell.

### Numbered Embodiment 33

The method according to any one of numbered embodiments 17 to 29, in which the electrochemical cell is an anode-free sodium cell.

### Numbered Embodiment 34

An electrochemical cell prepared by the method according to any one of numbered embodiments 19 to 33.

### Numbered Embodiment 35

An electrochemical cell having an electrolyte composition comprising a solvent system which comprises:
a first component comprising one or more non-aqueous solvents;
a second component comprising one or more performance additives selected from sulfur-containing compounds, boron-containing compounds, and surfactants; and
wherein the electrolyte composition further comprises one or more metal-containing salts in a concentration from 0 mol/kg to ≤0.2 mol/kg.

### Numbered Embodiment 36

The electrochemical cell according to numbered embodiment 35, in which the electrolyte composition is substantially free of one or more metal-containing salts.

### Numbered Embodiment 37

The electrochemical cell according to any one of numbered embodiments 35 to 36, in which the one or more non-aqueous solvents are selected from organo phosphate-based solvents, organo carbonate-based solvents, and glyme-based solvents.

### Numbered Embodiment 38

The electrochemical cell according to any one of numbered embodiments 35 to 37, in which the second component comprises one or more performance additives in an amount of >0.5 to 10% by weight of the solvent system.

### Numbered Embodiment 39

The electrochemical cell according to any one of numbered embodiments 35 to 38, in which the surfactants are selected from anionic surfactants, cationic surfactants, non-ionic (hydrophilic) surfactants and amphoteric (zwitterionic) surfactants.

### Numbered Embodiment 40

The electrochemical cell according to numbered embodiment 39, in which the surfactants include at least one non-ionic block copolymer surfactant, preferably selected from one or more poloxamers.

### Numbered Embodiment 41

The electrochemical cell according to any one of numbered embodiments 35 to 40, in which the sulfur-containing compounds are selected from sulfone-containing compounds, sulfate-containing compounds, and sulfonate-containing compounds.

### Numbered Embodiment 42

The electrochemical cell according to numbered embodiment 41, in which the sulfur-containing compounds include 1,3-propanediolcyclic sulfate (PCS).

### Numbered Embodiment 43

The electrochemical cell according to any one of numbered embodiments 35 to 42, in which the boron-containing compounds are selected from borate-containing compounds and boroxine-containing compounds.

### Numbered Embodiment 44

The electrochemical cell according to numbered embodiment 43, in which the boron-containing compounds include tris(trimethylsilyl) borate (TMSB).

### Numbered Embodiment 45

The electrochemical cell according to any one of numbered embodiments 35 to 44, in which the first component comprises triethyl phosphate in an amount of about 90% by weight or more of the first component of the solvent system.

### Numbered Embodiment 46

The electrochemical cell according to any one of numbered embodiments 35 to 45, in which the electrochemical cell is a sodium-based electrochemical cell.

### Numbered Embodiment 47

The electrochemical cell according to any one of numbered embodiments 35 to 45, in which the electrochemical cell is a metal-ion cell comprising a negative electrode, and a positive electrode.

### Numbered Embodiment 48

The electrochemical cell according to numbered embodiment 47, in which the metal-ion cell is selected from a sodium-ion cell, lithium-ion cell, and a potassium-ion cell.

### Numbered Embodiment 49

The electrochemical cell according to any one of numbered embodiments 35 to 45, in which the electrochemical cell is an anode-free sodium cell.

### Numbered Embodiment 50

An apparatus comprising an electrochemical cell according to any one of numbered embodiments 35 to 49.

### Numbered Embodiment 51

The apparatus according to numbered embodiment 50, in which the apparatus further comprises one or more electrochemical cells having an electrolyte composition comprising one or more metal-containing salts in a concentration of greater than 0.2 mol/kg.

1. An electrolyte composition comprising a solvent system which comprises:
a first component comprising one or more non-aqueous solvents;
a second component comprising one or more performance additives in an amount of >0.5 to ≤10% by weight of the solvent system selected from sulfur-containing compounds, boron-containing compounds, and surfactants; and
wherein the composition further comprises one or more metal-containing salts in a concentration from 0 mol/kg to ≤0.2 mol/kg.

2. The electrolyte composition according to claim 1, wherein the composition is substantially free of one or more metal-containing salts.

3. The electrolyte composition according to claim 1, wherein the one or more non-aqueous solvents are selected from organo phosphate-based solvents, organo carbonate-based solvents, and glyme-based solvents.

4. (canceled)

5. The electrolyte composition according to claim 1, wherein the surfactants are selected from anionic surfactants, cationic surfactants, non-ionic (hydrophilic) surfactants and amphoteric (zwitterionic) surfactants.

6. The electrolyte composition according to claim 5, wherein the surfactants comprise at least one non-ionic block copolymer surfactants.

7. The electrolyte composition according to claim 1, wherein the sulfur-containing compounds are selected from sulfone-containing compounds, sulfate-containing compounds, and sulfonate-containing compounds.

8. The electrolyte composition according to claim 7, wherein the sulfur-containing compounds comprise 1,3-propanediolcyclic sulfate (PCS).

9. The electrolyte composition according to claim 1, wherein the boron-containing compounds are selected from borate-containing compounds and boroxine-containing compounds.

10. The electrolyte composition according to claim 9, wherein the boron-containing compounds comprise tris(trimethylsilyl) borate (TMSB).

11. The electrolyte composition according to claim 1, wherein the first component comprises triethyl phosphate in an amount of about 90% by weight or more of the first component of the solvent system.

12. (canceled)

13. (canceled)

14. (canceled)

15. (canceled)

16. (canceled)

17. (canceled)

18. (canceled)

19. A method of manufacturing an electrochemical cell comprising:
introducing to the electrochemical cell, an electrolyte composition comprising a solvent system which comprises:
a first component comprising one or more non-aqueous solvents;
a second component comprising one or more performance additives in an amount of >0.5 to ≤10% by weight of the solvent system selected from sulfur-containing compounds, boron-containing compounds, and surfactants; and
wherein the electrolyte composition further comprises one or more metal-containing salts in a concentration from 0 mol/kg to ≤0.2 mol/kg.

20. An electrochemical cell having an electrolyte composition comprising a solvent system which comprises:
a first component comprising one or more non-aqueous solvents;
a second component comprising one or more performance additives in an amount of >0.5 to ≤10% by weight of the solvent system selected from sulfur-containing compounds, boron-containing compounds, and surfactants; and
wherein the electrolyte composition further comprises one or more metal-containing salts in a concentration from 0 mol/kg to ≤0.2 mol/kg.

21. An apparatus comprising an electrochemical cell according to claim 20.

22. (canceled)

23. (canceled)

24. An electrolyte composition according to claim 6, wherein the at least one non-ionic block copolymer surfactants comprise one or more poloxamers.

25. The electrochemical cell according to claim 20, wherein the electrochemical cell is a sodium-based electrochemical cell.

26. The electrochemical cell according to claim 20, wherein the electrochemical cell is a metal-ion cell comprising a negative electrode and a positive electrode.

27. The electrochemical cell according to claim 26, wherein the metal-ion cell is selected from a sodium-ion cell, a lithium-ion cell, and a potassium-ion cell.

28. The electrochemical cell according to claim 25, wherein the electrochemical cell is an anode-free sodium cell or a sodium metal cell.

29. The electrochemical cell according to claim 20, wherein the electrochemical cell is associated or integrated with one or more additional electrochemical cells having one or more metal-containing salts in a concentration of greater than 0.2 mol/kg.
